(19) United States
(12) Patent Application Publication
(10) Pub. No.: US 2006/0036748 A1
(43) Pub. Date: Feb. 16, 2006

(54) Apparatus and method for computerized information management

(76) Inventors: Edward S. Nusbaum, Scottsdale, AZ (US); Paul T. Nixon, Mountain View, CA (US); Patrick G. Borjon, Anchorage, AK (US)

Correspondence Address: Mark F. Wright;Wright Law Group, PLLC, Suite 2, 7201 West Oakland, Chandler, AZ, 85226, US

(21) Appl. No.: 11/193,058

(22) Filed: Jul. 28, 2005

Related U.S. Application Data
(60) Provisional application No. 60/591,979, filed on Jul. 28, 2004.

(51) Int. Cl. G06F 15/16; G06F 17/30

(52) U.S. Cl. 709/228; 707/3

(57) ABSTRACT

An effective and efficient process for providing access to, customizing, and updating various types of information provided via a computer network such as the Internet is disclosed. In the most preferred embodiments of the present invention, an individual or organization provides specific information to create a master information profile. Additionally, the owner of the information can then provide selectively tailored “views” of the information contained in the master information profile to selected individuals or groups. This allows selectively tailored information, formatted and presented on a web page, to be quickly and easily made available to selected groups, individuals and public Internet search engines such as Google and Yahoo.

### FIELD OF THE INVENTION

The present invention relates generally to information management and more particularly relates to the use of computer networks in the process of locating, updating, exchanging and managing information.

### BACKGROUND OF THE INVENTION

The interconnected nature of the modem world has been greatly enhanced by the advent, acceptance, and continued growth of computers and computer networks such as the Internet. Computers have proven to be capable tools for quickly and easily capturing, storing, and sharing information around the world. Indeed, computers are now both relatively low in cost and ubiquitous in their presence, thereby providing easy access to all types of information for many segments of our society. This rapid adoption and spread of technology has made it very simple for information about people and things to be spread from one location to another and also for groups and individuals to get and remain connected. Computer based e-mail, instant messaging, contact management software applications, cyberspace “groups,” etc., have provided unprecedented communication capabilities to individuals and organizations. The result has been expanded opportunities for individuals and organizations to increase their productivity and enhance their relationships by using the now omnipresent technology-based infrastructure.

In fact, there are many computer-based tools that have been developed for the specific purpose of allowing individuals and organizations to find each other, get connected, and stay connected over time. For example, there are various “six degrees of separation” websites that are based on the premise that each person in the world can be connected to any other person in the world by, at most, six “links” or other people. By using these various sites, people and organizations can form complex networks of interrelationships that allow them to contact other participants in the same network. Other websites allow you to “upload” all of the contact information in your database and then quickly and easily contact everyone in your database to request updated information from your contacts. Many other similar services are now available, each striving to provide more efficient means of connecting disparate parties and communicating information, wherever they may be.

Unfortunately, the increased availability of technological tools for generating, sharing, and exchanging information has proved to be a two-edged sword. While it has become far easier for people and organizations to get and stay connected with their desired contacts, it has also become easier for profit-minded businesses, unscrupulous individuals, and the like to gather and exploit information, particularly personally identifiable information, about third parties. While some of these externally initiated contacts may be desirable, many individuals wish to safeguard their personal information and have no wish to be contacted by unknown individuals. The curse of “spam” and even more problematic issue of identity theft are greatly exacerbated by easy access to computer technology.

For example, if one person uses an automated e-mail to request an update of an individual's contact information, that may not be a problem. But if each person that required updated contact information were to send the same request to the same person, this methodology could quickly become overwhelming for a given individual. Additionally, with many of the presently available technologies, once an individual or entity “joins” the group and makes their contact information available, that information is exposed, to a greater or lesser extent, to every other individual or entity that has similarly elected to participate in the group. This means that any contact information provided to the group may inadvertently become available to undesirable third parties. Basically, it is very easy to lose control of the information once it has been submitted.

Another limitation of presenting information via computer networks, including the Internet, to a broad audience is, by necessity, the generic nature of most information. For example, given that it is difficult to know exactly who is viewing the information at a website, the information is usually presented in the most inclusive and conservative manner possible. For mass market products with a large potential audience, this type of approach will usually be sufficient. However, in some cases, it might be desirable to more closely tailor the information for a specific visitor or group of visitors. While this may be accomplished for a limited number of visitors, the sheer number of visitors to any given website makes this approach somewhat impractical on a large scale. One attempt to solve this problem is the creation of “members only” areas and other controlled access entry methodologies. However, as previously stated, the limitations to these approaches are substantial.

Yet another limitation and deficiency associated with presently available contact-sharing technologies is the problem of continued relevance over time. For example, people are increasingly mobile and change jobs and residences on a very frequent basis. Accordingly, even after exchanging contact information with one or more individuals, it is quite likely that some, if not all, of the contact information may be outdated shortly after being collected. That is why there has been a notable increase in the availability of various contact-management related software solutions made available over the Internet to enhance the probability of maintaining contact once established. This makes it difficult to find and contact people using the Internet. For example, once a person's e-mail address changes, it may be difficult to contact them using standard search techniques because e-mail addresses, particularly old e-mail addresses, are not usually catalogued and made available for searching. Accordingly, old e-mail addresses quickly become a dead end prospect for searching. Additionally, it can be difficult, if not impossible, to find a person's contact information without access to certain specific personal identifying information. Several technologies, such as Internet white pages, purportedly attempt to resolve these types of problems. However, as previously explained, many of the existing solutions introduce as many problems as they purport to solve.

While the various presently known methodologies of information presentation and management are not without merit, most existing implementations for providing, updating and protecting information, particularly over the Internet, have one or more significant drawbacks. Given the present situation and, using the current technology, additional opportunities for the customized information presentation along with the streamlined and controlled dissemination of information, are somewhat unlikely. Additionally, given the current limitations inherent in the existing technology, even those users who have elected to participate in the present offerings are often unable to adequately access information and control, update, and exchange their information in a timely and efficient fashion. Accordingly, without developing improved methods of simplifying the task of presenting, updating and exchanging information, the overall process of sharing, maintaining, and protecting various types of information over computer networks such as the Internet will continue to be sub-optimal.

### SUMMARY OF THE INVENTION

The apparatus and methods of the present invention create an effective and efficient process for providing access to, customizing, and updating various types of information provided via a computer network such as the Internet. Additionally, in the context of personally identifiable information (PII) such as contact information, the present invention provides a way to make selected information available to public search engines while avoiding unwanted intrusions from undesired contacts. In the most preferred embodiments of the present invention, an individual or organization provides specific information to create a master information profile. Additionally, the owner of the information can then provide selectively tailored “views” of the information contained in the master information profile to selected individuals or groups. This allows selectively tailored information, formatted and presented on a web page, to be quickly and easily made available to selected groups, individuals and public Internet search engines such as Google and Yahoo.

### DESCRIPTION OF THE DRAWINGS

The various preferred embodiments of the present invention will hereinafter be described in conjunction with the appended wherein like designations denote like elements and:

FIG. 1 is a block diagram of a computer-based information exchange system for providing customized views of information and controlling access to information in accordance with a preferred embodiment of the present invention;

FIG. 2 is a block diagram of a computer used to provide customized views of information and control access to information in accordance with a preferred embodiment of the present invention;

FIG. 3 is a block diagram depicting a master profile and a custom profile for providing customized views of information and controlling access to information in accordance with a preferred embodiment of the present invention;

FIG. 4 is a flow chart for a method of providing customized views of information and controlling access to information in accordance with a preferred embodiment of the present invention;

FIG. 5 is a schematic diagram of a network for providing customized views of information and controlling access to information in accordance with a preferred embodiment of the present invention;

FIG. 6 is a schematic diagram of access groups in accordance with a preferred embodiment of the present invention;

FIG. 7 is a flow chart for a method of requesting access to information in accordance with a preferred embodiment of the present invention;

FIG. 8 is a flow chart for a method of providing access to information in accordance with a preferred embodiment of the present invention;

FIG. 9 is a schematic diagram of a contact information management system in accordance with a preferred embodiment of the present invention;

FIG. 10 is a sample web page or “access point” in accordance with a preferred embodiment of the present invention; and

FIG. 11 is a sample web page for a group in accordance with a preferred embodiment of the present invention.

### DETAILED DESCRIPTION

The apparatus and methods of the present invention create an effective and efficient process for both providing access to and customizing various types of information provided via a computer network such as the Internet. In the most preferred embodiments of the present invention, an individual or organization provides specific information to create a master information profile. Additionally, the owner of the information can then provide selectively tailored “views” of the information contained in the master profile to selected individuals or groups. This allows the selectively tailored information, such as contact information, to be formatted and presented on a web page where it can be quickly and easily made available to selected individuals and/or public search engines. It should be noted that any or all of the information from the master profile may be used as a custom profile, if desired by the user.

The present invention will be described herein as an information exchange system that allows system users to exchange information by using a simple “door” and “card” analogy. Basically, the various preferred embodiments of the present invention allow each system user to create one or more custom “cards” containing user selectable information (in the most preferred embodiments of the present invention, the “cards” are subsets of information contained in a computer database and may be designated as “information profiles” or “custom information profiles”). Additionally, each system user can create one or more “doors” (in the most preferred embodiments of the present invention, the “doors” are embodied as web pages accessible via system-generated or custom URLs and may be designated as “access points”). In the most preferred embodiments of the present invention, the URL incorporates a globally unique identifier representing the person, group, product, etc. that may be accessed through the identified access point.

While an access point or door is not a card, an access point will typically contain information that is consistent with the information stored in a database for a given user. Accordingly, each user-created door may present any type of identifying information that the owner of the door deems advisable and/or desirable. This may include text and graphics as well as other types of data. The publicly available information posted on a given user's door is dictated by the user and is drawn from the information about the user stored in the master profile database. These various doors are then made publicly available and, upon request through a door, cards can then be exchanged with other system users as desired. An exchange of information cards typically takes place only after someone “knocks” on a door and presents at least one card of their own. This becomes a request for information or a “connection request.” As part of the connection request, the individual making the request may also choose to include a request-specific message when their card is presented. This means that a typical connection request will generally include any publicly available information associated with the information requester's door, a subset of the information associated with the card proffered at the time of the connection request (if any), and the optional message.

Then, the individual or entity on the “inside” of the door (information provider) makes a decision whether or not to exchange information with the individual or entity on the outside of the door (information requester), based on the information contained in the connection request. In this fashion, true permission-based contact information exchanges are performed. In addition, in order to provide the most protection possible for PII, the information available to the exchanging parties will typically be different prior to and after the exchange of the cards in the most preferred embodiments of the present invention.

For example, prior to an agreement to exchange cards, the users will typically see a limited subset of the information contained on the other user's card. In the case of contact information, this may include the name of the company or state of residence or some other fairly generic information. However, after the users have agreed to exchange cards, all of the information on the exchanged cards, including any PII, may then be made available to each user. Various methods may be used to generate revenue for the operators of the system. For example, advertising revenue may be generated by the system by placing product or service related ads in various locations on the site. Alternatively, or in addition to site-level advertisements, targeted advertisements may be included with the requests for information and the responses to requests for information.

Additionally, a user may be charged for the use of the service in general, and/or for the ability to view and/or accept incoming connection requests. Similarly, a user may be charged for the ability to initiate connection requests and/or when their connection requests are accepted. In yet another preferred embodiment of the present invention, a gift “subscription” may be offered in the form of one user paying for another users use of the service in return for a connection between the two users being created and maintained for the duration of the subscription. Once enough users have joined the system, additional revenue may be generated by licensing the capability to stay connected with the users for those organizational entities with a significant number of members participating in the system. The various functions and capabilities of the system may be made available to third parties via an application programming interface.

In addition to providing permission-based information exchanges, each exchange of cards by two system users provides an on-going connection or “link” between the cards for the individuals or entities that exchanged the cards. Additionally, once cards have been exchanged, the information associated with the exchanged cards is automatically updated by the information exchange system whenever either one of the owners of the information contained in the cards updates the information on their respective card. This approach can be especially valuable in the exchanging of contact information between individuals. Finally, if and when any user decides to stop sharing information with any other user of the system, they can “break” the link and remove the previously granted information access.

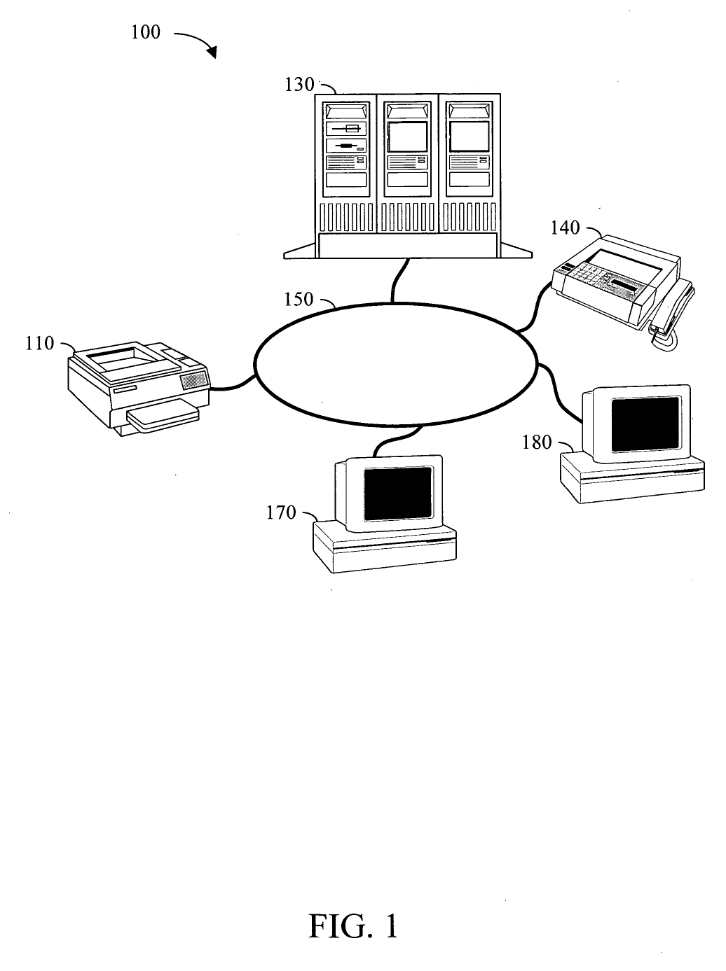

Referring now to FIG. 1, a block diagram of a computer-based information exchange system 100 for providing customized views of information and for controlling access to information in accordance with a preferred embodiment of the present invention comprises: a data server 130; an information requesting computer system 170; and an information providing computer system 180, all connected or coupled via a network 120. Additionally, an optional printer 110 and an optional fax machine 140 are shown. Taken together, the various components of computer-based information exchange system 100 provides a way for individuals, organizations, businesses, and the like to more efficiently and effectively create, customize, process, exchange, and manage access to information, specifically contact information, as described herein in conjunction with the various preferred embodiments of the present invention.

Data server 130 represents a relatively powerful computer system that is made available to information requesting computer system 170 and information providing computer system 180 via network 120. Various hardware components (not shown this FIG.) such as external monitors, keyboards, mice, tablets, secondary storage devices, hard disk drives, recordable CD-ROM/DVD drives and/or burners, jukeboxes, fax servers, magnetic tapes, and other devices known to those skilled in the art may be used in conjunction with data server 130. Data server 130 may also include various software components (not shown this FIG.) such as database servers, web servers, firewalls, security software, and the like. The use of these various hardware and software components is well known to those skilled in the art. Given the relative advances in the state-of-the-art computer systems available today, it is anticipated that the various functions of data server 130 may be provided by many standard, readily available data servers. Depending on the desired size and relative power required for data server 130, storage area network (SAN) technology may also be deployed in certain preferred embodiments of the present invention.

Information requesting computer system 170 and information providing computer 180 may be any type of computer system known to those skilled in the art that is capable of being configured for use with computer-based information exchange system 100 as described herein. This includes laptop computers, desktop computers, tablet computers, pen-based computers and the like. Additionally, handheld and palmtop devices are also specifically included within the description of devices that may be deployed as an information requesting computer system 170. It should be noted that no specific operating system or hardware platform is excluded and it is anticipated that many different hardware and software platforms may be configured to create information requesting computer system 170. As previously explained in conjunction with data server 130, various hardware components and software components (not shown this FIG.) known to those skilled in the art may be used in conjunction with information requesting computer system 170. It should be noted that in many preferred embodiments of the present invention, information requesting computer system 170 is linked to its own LAN or WAN and has access to its own data server (not shown this FIG.).

Network 120 is any suitable computer communication link or communication mechanism, including a hardwired connection, an internal or external bus, a connection for telephone access via a modem or high-speed data line (T1, T3, etc.), radio, infrared or other wireless communications, public, private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, broadcast cable transmission line, Digital Subscriber Line (DSL), ISDN line, or similar public utility-like access link. Different portions of network 120 may be configured and implemented using any or all of the various options described herein.

In the most preferred embodiments of the present invention, network 120 represents and comprises a standard Internet connection between the various components of computer-based information exchange system 100. Network 120 provides for communication between the various components of computer-based information exchange system 100 and allows for relevant information to be transmitted from device to device. In this fashion, users of computer-based information exchange system 100 can quickly and easily gain access to the relevant data and information as described in conjunction with the preferred embodiments of the present invention. Regardless of physical nature and topology, network 120 serves to logically link the physical components of computer-based information exchange system 100 together, regardless of their physical proximity. This is especially important because in many preferred embodiments of the present invention, data server 130, information requesting computer system 170, and information providing computer system 180 may be geographically remote and separated from each other.

In general, data server 130 stores information and processes requests for various transactions, including requests for the information stored on data server 130, between information requesting computer system 170 and information providing computer system 180. A typical transaction may be represented by a request for access to certain information made by one individual or entity relative to another individual or entity. In the most preferred embodiments of the present invention, the request may be made via a web-based application running on data server 130 and accessed by the user of information requesting computer 170 via any standard web browser, using the Internet. In this case, a request for access to certain information is sent from information requesting computer system 170 to data server 130. Data server 130 processed the request, formats the request for processing and, as necessary, transfers the request for access to information providing computer system 180. The request may also generate an automatic response, based on certain pre-set permission parameters associated with and controlled by the owner of the information requested. This request for access to information may be accomplished by any of the methodologies in presented in conjunction with the various preferred embodiments of the present invention described herein.

Upon receiving the request for access to certain information from data server 130, the user of information providing computer system 180 can determine whether or not to grant access to any or all of the information controlled by the user and as requested by information requesting computer 170. The approval or disapproval of the request for access is routed by data server 130 and made available to information requesting computer 170 by any of the methodologies presented in conjunction with the various preferred embodiments of the present invention described herein. Additionally, if the request for access to information is granted, the authorized information may be transmitted from data server 130 to information requesting computer 170. As previously explained, the access to the requested information may also be automatically granted based on pre-established criteria. In the most preferred embodiments of the present invention, the request for access to certain information will typically be answered by providing access to a custom information profile as described in conjunction with the various preferred embodiments of the present invention as describer herein.

It should be noted that the roles of information requesting computer system 170 and information providing computer system 180 may be interchanged, depending on which user initiates the request for access to the information. Additionally, it should be noted that while FIG. 1 shows only a single information requesting computer system 170 and a single information providing computer system 180, it is anticipated that the most preferred embodiments of the present invention may comprise virtually all computers and computer systems that may be connected via computer networks such as the Internet.

In the most preferred embodiments of the present invention, multiple information requesting computer systems 170 and multiple information providing computer systems 180 will all be configured to communicate with data server 130 and with each other via network 120. In addition, the most preferred embodiments of the present invention include an Application Service Provider (ASP) environment where data server 130 is operated as a clearinghouse in a hosted operation. In this fashion, multiple information requesting computer systems 170 and information providing computer systems 180 may be provided with access to data server 130 on an as-needed basis. Data server 130 is further described below in conjunction with FIG. 8 below.

Optional printer 110 and an optional fax machine 140 are standard peripheral devices that may be used for transmitting or outputting paper-based documents, notes, transactions, reports, etc. in conjunction with the queries and transactions processed by computer-based information exchange system 100. Optional printer 110 and an optional fax machine 140 may be directly connected to network 120 or indirectly connected via any or all of information requesting computer systems 170, information providing computer systems 180, and/or data server 130. Finally, it should be noted that optional printer 110 and optional fax machine 140 are merely representative of the many types of peripherals that may be utilized in conjunction with computer-based information exchange system 100. It is anticipated that other similar peripheral devices may be deployed in the various preferred embodiment of the present invention and no such device is excluded by its omission in FIG. 1.

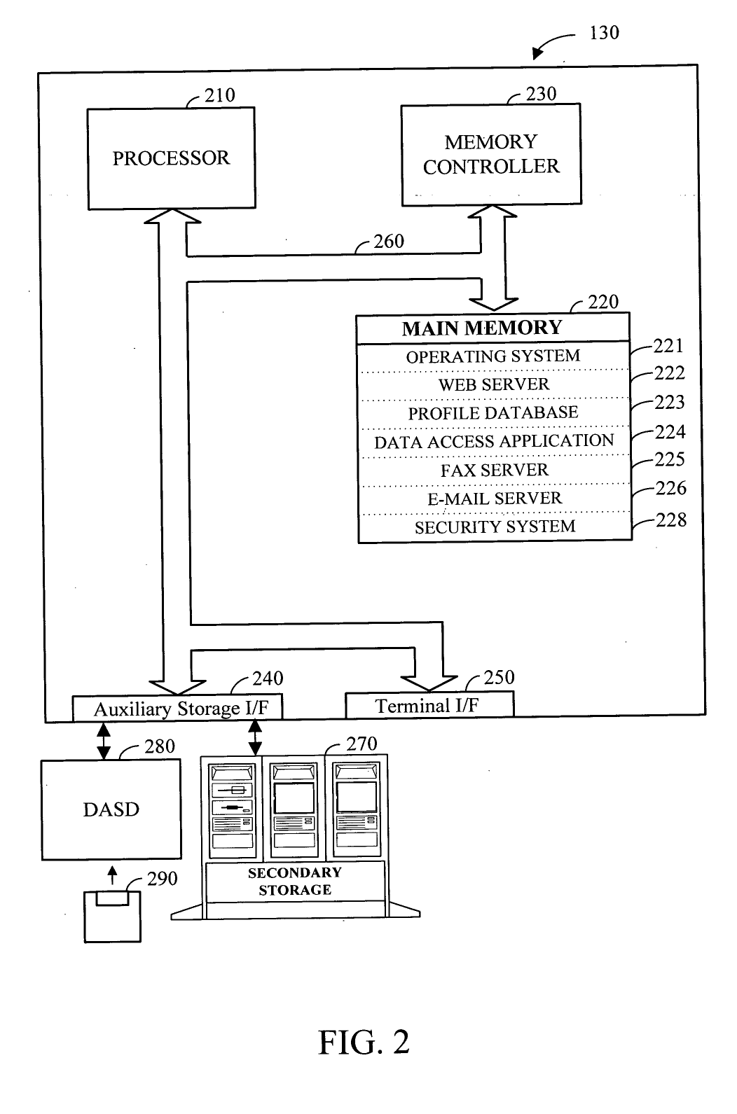

Referring now to FIG. 2, data server 130 in accordance with a preferred embodiment of the present invention is most preferably a commercially available computer system such as a Linux-based computer system, IBM compatible computer system, or Macintosh computer system. However, those skilled in the art will appreciate that the methods and apparatus of the present invention apply equally to any computer system, regardless of whether the computer system is a traditional “mainframe” computer, a complicated multi-user computing apparatus or a single user device such as a personal computer or workstation.

Data server 130 suitably comprises at least one Central Processing Unit (CPU) or processor 210, a main memory 220, a memory controller 230, an auxiliary storage interface (I/F) 240, and a terminal interface (I/F) 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the salient features of data server 130.

Processor 210 performs computation and control functions of data server 130, and comprises a suitable central processing unit (CPU). Processor 210 may comprise a single integrated circuit, such as a microprocessor, or may comprise any suitable number of integrated circuit devices and/or circuit boards working in cooperation to accomplish the functions of a microprocessor. Processor 210 suitably executes one or more software programs contained within main memory 220.

Auxiliary storage interface 240 allows data server 130 to store and retrieve information from auxiliary storage devices, such as secondary storage device 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a floppy disk drive that may read programs and data from a floppy disk 290.

It is important to note that while the present invention has been (and will continue to be) described in the context of a fully functional computer system, those skilled in the art will appreciate that the mechanisms (particularly profile database 223 and/or data access application 224 of FIG. 2) of the present invention are capable of being distributed in conjunction with signal bearing media as one or more program products in a variety of forms, and that the various preferred embodiments of the present invention applies equally regardless of the particular type or location of signal bearing media used to actually carry out the distribution. Examples of suitable signal bearing media include: recordable type media such as floppy disks (e.g., disk 290) and CD ROMS, and transmission type media such as digital and analog communication links, including standard network connections and wireless communication links.

In the most preferred embodiments of the present invention, various preferred embodiments of the program product may be configured to communicate with the various entities involved in a typical information request and reply transaction, identify the participants in the transaction request, create and update master information profile data and custom information profile data contained in profile database 223 to create, update and transmit one or more communications requests, etc. In this fashion, the appropriate entities (i.e., friends, acquaintances, customers, vendors, etc.) can utilize the program product to initiate and complete a wide variety of information-based transactions.

In the most preferred embodiments of the present invention, memory controller 230, through use of an auxiliary processor (not shown) separate from processor 210, is responsible for moving requested information from main memory 220 and/or through auxiliary storage interface 240 to processor 210. While for the purposes of explanation, memory controller 230 is shown as a separate entity; those skilled in the art understand that, in practice, portions of the functions provided by memory controller 230 may actually reside in the circuitry associated with processor 210, main memory 220, and/or auxiliary storage interface 240.

Terminal interface 250 allows users, system administrators and computer programmers to communicate with data server 130, normally through separate workstations or through stand-alone computer systems such as information requesting computer systems 170 and information providing computer systems 180 of FIG. 1. Although data server 130 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be suitably employed.

Main memory 220 most preferably contains an operating system 221, a web server 222, profile database 223, a data access application 224, a fax server 225, an e-mail server 226, and a security system 228. The term “memory” as used herein refers to any storage location in the virtual memory space of data server 130.

It should be understood that main memory 220 may not necessarily contain all parts of all components shown. For example, portions of operating system 221 may be loaded into an instruction cache (not shown) for processor 210 to execute, while other files may well be stored on magnetic or optical disk storage devices (not shown). In addition, although data access application 224 is shown to reside in the same memory location as operating system 221, it is to be understood that main memory 220 may consist of multiple disparate memory locations. It should also be noted that any and all of the individual components shown in main memory 220 may be combined in various forms and distributed as a stand-alone program product. Finally, it should be noted that additional components, not shown in this figure may also be included.

For example, the most preferred embodiments of the present invention may also include a security and/or encryption facility for verifying access to the data and information contained in and transmitted by data server 130. Additionally, the security mechanism may also provide encryption capabilities for computer-based information exchange system 100, thereby enhancing the robustness of computer-based information exchange system 100. Once again, depending on the type and quantity of information stored in profile database 223, data server 130 may provide different levels of security and/or encryption for different computer systems 170 and 180. Additionally, the level and type of security measures applied by data server 130 may be determined by the nature of a given request and/or response. In some preferred embodiments of the present invention, profile database 223 may contained in or implemented in conjunction with certain hardware components (not shown this FIG.) such as hardware-based firewalls, switches, dongles, and the like.

Operating system 221 typically includes the software that is used to operate and control data server 130. In general, processor 210 typically executes operating system 221. Operating system 221 may be a single program or, alternatively, a collection of multiple programs that act in concert to perform the functions of an operating system. Any operating system known to those skilled in the art may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or may develop web servers that are suitable for use with the various preferred embodiments of the present invention. Finally, while depicted as a single device, in certain preferred embodiments of the present invention web server 222 may be implemented as a cluster of multiple web servers. This configuration is generally recognized as providing additional robustness for system uptime and reliability purposes. Regardless of the specific form of implementation, Web server 222 provides system access, including a web browser-base user interface, to allow individuals and entities to interact with profile database 223 and data access application 224, including communication via network 120 of FIG. 1.

As previously explained in conjunction with FIG. 1, profile database 223 is used to store master information profile data and custom information profile data. Accordingly, it should be noted that profile database 223 is representative of any database suitable for storing large quantities of information known to those skilled in the art. Profile database 223 may be implemented using a standard Relational Database Management System (RDBS), a flat file structure, etc. In the most preferred embodiments of the present invention, profile database 223 is a Structured Query Language (SQL) compatible database file capable of storing information relative to the various users and entities that access profile database 223, including the names, addresses, account preferences, etc. for the users. While profile database 223 is shown to be residing in main memory 220, it should be noted that profile database 223 may be physically located in a location other than main memory 220. For example, profile database 223 may be stored on secondary storage device 270 or DASD 280 and coupled to data server 130 via auxiliary storage I/F 240. Additionally, profile database 223 may be a segmented database stored in multiple disparate locations.

Data access application 224 is any computer program suitable for creating and/or maintaining and manipulating the information needed to fulfill the information request and respond methodologies presented herein. Most preferably, data access application 224 is a software application designed to receive, review, format and process requests for access to information stored in profile database 223. Additionally, data access application 224 is configured to transmit and/or present the profile information stored in profile database 223 in a variety of formats, depending on the type of information requested and the type of access authorized in respond to a given request. While data access application 224 is shown to be residing in main memory 220, it should be noted that data access application 224 may be physically located in a location other than main memory 220. For example, data access application 224 may be stored on external storage device 270 or DASD 280 and coupled to data server 130 via auxiliary storage I/F 240.

By extension, each and every parameter necessary to create and/or update any profile found in profile database 223 may be accessed via data access application 224. The creation and update process for the profiles stored in profile database 223 may be managed by the individuals or entities that own the profiles themselves via a standard web browser. The individuals or entities can use their web browser to access profile database 223 and data access application 224 via web server 222, thereby creating, updating, exchanging, and otherwise managing the relevant information for their respective profiles.

It should be noted that profile database 223 and/or data access application 224 may be stored at a geographically remote location that is accessible via the Internet, by utilizing any suitable Internet file transfer application (XML, SOAP, etc.). In this type of distributed database environment, profile database 223 may be implemented using various techniques known to those skilled in the art to prevent data redundancy and to ensure data integrity. Additionally, in the most preferred embodiments of the present invention, information for various file transfer protocols and specifications for communicating with computer systems 170 and 180 of FIG. 1 are also contained in data access application 224.

While not required, the most preferred embodiments of data server 130 of FIG. 1 will also typically include a fax server 225. Fax server 225 is any fax server known to those skilled in the art and is configured to receive inbound fax messages and to transmit outbound fax messages. Fax server 225 may format and transmit any fax-formatted data processed by any user of computer-based information exchange system 100 of FIG. 1 and make it available for use by any other component of computer-based information exchange system 100 of FIG. 1. Additionally, fax server 225 may process the data received and send it directly to data access application 224 and make the incoming data available for further processing by computer-based information exchange system 100, including data access application 224.

While not required, the most preferred embodiments of data server 130 of FIG. 2 will also typically include an e-mail server 226. E-mail server 226 is any e-mail server application capable of being configured and used to send and receive various status messages and updates between computer systems 170 or 180 of FIG. 1 via e-mail, as may be necessary to enhance the overall process of information management as described herein. This includes the generation of automated e-mail messages relating to the preferred embodiments of the present invention for requests and responses to requests for access to information, etc. Other forms of standard and electronic messaging systems (e.g., instant messaging, phone messaging, telegrams, and the like) may also be utilized in conjunction with the various embodiments of the present invention.

Finally, data server 130 will most preferably include a security system 228 deployed in conjunction with profile database 223 and data access application 224. System 228 is deployed generally to deter system abuse and may also incorporate applications and routines such as firewalls, etc. to prevent unauthorized access to data server 130. Further discussion of security system 228 is provided below.

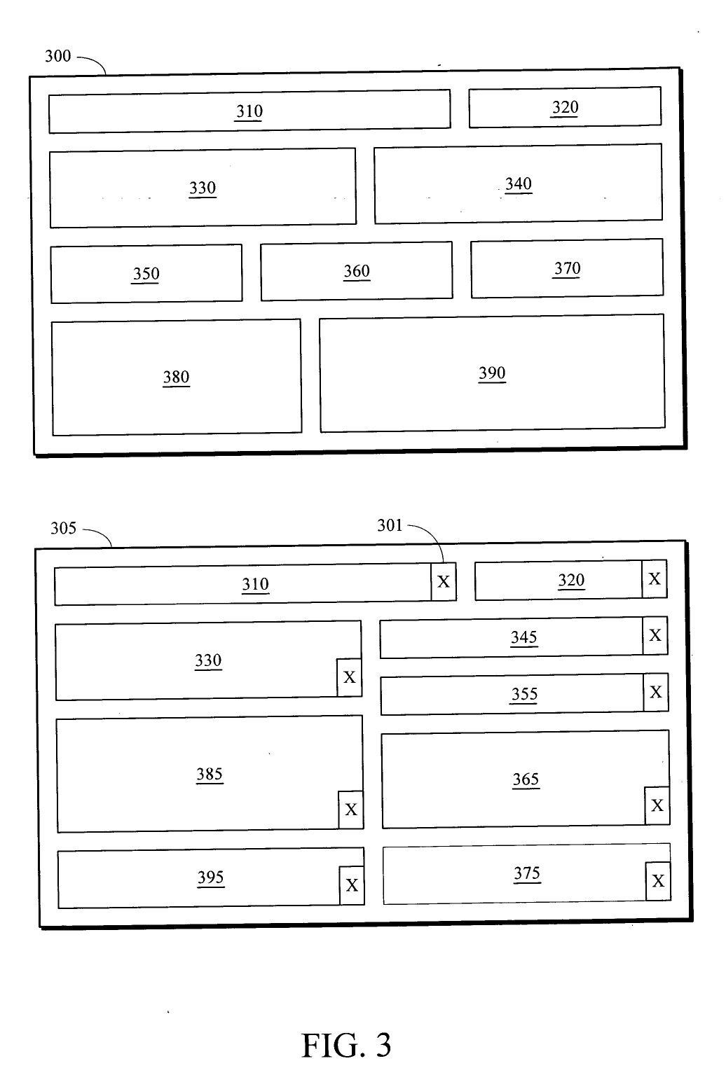

Referring now to FIG. 3, a master information profile 300 and a custom information profile 305 in accordance with a preferred embodiment of the present invention are represented. As shown in FIG. 3, master information profile 300 comprises a plurality of data fields 310-390. In this specific embodiment of the preferred invention, each of data fields 310-390 are representative of a specific data element related to an individual or entity, such as is typical for a contact management application. For this specific embodiment of the invention, data fields 310-390 may include information such as name, physical address, phone number, e-mail address, birth date, educational level, professional/fraternal/religious affiliations, etc. A user may choose to enter all, some, or none of the information requested for data fields 310-390. As the user creates a master information profile 300 by entering some or all of the requested information into data fields 310-390 and the information entered by the user is stored in a profile database (not shown this FIG.). In the most preferred embodiments of the present invention, master information profile 300 is not displayed to anyone but the owner of the information and is a “private view” of the information for a given user. However, in certain embodiments and under certain conditions, it may be desirable to exchange master information profile 300 with another user. Additionally, master information profile 300 may or may not contain all of the information related to the user that is contained in the master profile database.

Custom information profile 305 represents a specific customized view of the information stored in the master profile database and, in most preferred embodiments of the present invention be displayed publicly to selected individuals. In this example, custom information profile 305 includes some of data fields 310-390 but also includes data fields 345, 355, 365, 375, 385, 395, which are not shown on master information profile 300, but could be shown on master information profile 300 in certain preferred embodiments of the present invention. Whether or not the information shown on custom information profile 305 is shown on any other information profile or not, it is all stored in profile database (not shown this FIG.). It should be noted that, depending on the specific application requirements, a user may create multiple custom information profiles, each with its own specific presentation of the information contained in the profile database (not shown this FIG.).

Additionally, as shown in FIG. 3, each data field 310-395 associated with custom information profile 305 has a display indicator 301 associated with it. Display indicator 301 allows a user to selectively hide or show a specific data field 310-395 by “checking” or “unchecking” the display indicator 301 associated with a specific data field 310-395. Additionally, any information entered into master information profile 300 and/or any custom information profile 305 is stored in the profile database (not shown this FIG.) and is available for use with any other, subsequently created custom information profile 305 via the profile database (not shown this FIG.). For example, if the user name is included on multiple custom information profiles 305, it does not need to be entered every time a new custom profile 305 is created since the information already exists in the profile database and can simply be retrieved from that location and included as necessary. This obviates the need for re-keying data in subsequent custom information profile creation activities.

In essence, by employing the methods of the present invention, a user may create multiple custom information profiles from a single profile database (not shown this FIG.), with the same or different views of the information contained in the profile database (not shown this FIG.) and present any or all of the selected information to selected individuals. In this fashion, the user has complete control over the presentation of their information and the access to their information.

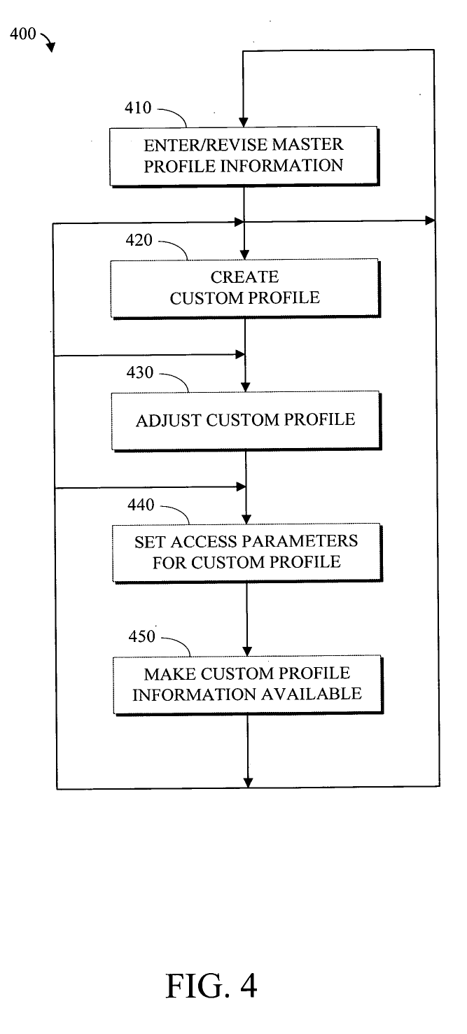

Referring now to FIG. 4, a method 400 for creating a master profile 300 and a custom profile 305 of FIG. 3 in accordance with a preferred embodiment of the present invention is depicted. To start, a user may set up a user account and enter various information elements into a profile database as previously explained in conjunction with FIG. 3 (step 410). Next, the user may optionally create at least one custom information profile as previously explained in conjunction with FIG. 3 (step 420). As previously explained, the custom information profile may be repeatedly adjusted (step 430) as desired to selectively include the specific desired information. While depicted as separate steps, the creation process may actually occur simultaneously because the process of entering information into a master information profile for the first time may also create the first custom information profile. In the most preferred embodiments of the present invention, the user can then create additional custom information profiles and the information from their profile database, if previously entered, may be automatically transferred to each new custom information profile as it is created.

Additionally, in certain preferred embodiments of the present invention, information that is not originally contained in the master information profile but that is added to a custom information profile may be selectively and automatically transferred to the profile database, thereby maintaining one central information repository for all related information. Finally, in the most preferred embodiments of the present invention, any changes to a given information field associated with any custom information profile may automatically be updated in other custom information profiles that contain the same information field.

After one or more custom information profiles have been created and modified to contain and display the desired information, the access parameters for the custom profile can be set (step 440). The access parameters provide a way for the owner of the information contained in the custom information profile to control what individuals or entities gain access to the custom information profile. For example, the owner of the information contained in the custom profile may make a given custom information profile available to any number of requesters, individually or in groups and may be automatically provided based on an access code or similar procedure. The provision of access to a given custom information profile is discussed in additional detail below. Finally, the custom information profile may be made available (step 450). The various ways that a given custom information profile may be made available are discussed below (automatically, upon request, etc.).

As shown in FIG. 4, steps 420-450 may be repeated numerous times in order to create and/or update and/or provide the desired number of custom profiles to the desired parties. In this fashion, very specific profiles containing very specific data can be made available to a wide variety of audiences. By carefully tailoring the data associated with a given custom profile, and by selectively providing the appropriate custom information profile, an individual or entity can retain tight control over their information. Finally, it should be noted that the user may also return to step 410 and revise the information in the profile database at any time.

Once created as described in conjunction with FIG. 4, each custom information profile may be made available by request at an “access point.” The access point is typically a web page that is accessible to any computer user that has access to the network (e.g., the Internet). In the most preferred embodiments of the present invention, a globally unique identifier is used to identify and link to the access point for requesting the specific information associated with a given custom information profile. The globally unique identifier is most preferably a system generated identifier and may be presented in many forms and may be incorporated into multiple addressing mediums. For example, in the most preferred embodiments of the present invention, a URL for a door or access point may consist of a domain name, additional sub-domain domain information, and will also contain a globally unique identifier that consists of three alpha characters followed by three numeric characters. Using this methodology, a sample URL including a system generated globally unique identifier could take the form “http://www.contactlink.com/door/xxx###.”

As previously mentioned, custom globally unique identifiers, personally selected by the individual system users, are also possible as well. In either case, whether using a system generated URL or a custom URL, at least a portion of the URL will serve as a globally unique identifier for the information associated with the individual, group, person, or object that is accessible via the URL. Upon reaching the access point or web page associated with the URL, the user can review the web page and, based upon the information presented at the web page, decide whether or not to request a custom information profile via that access point. In the most preferred embodiments of the present invention, the various web pages are dynamically created at the time a request for a specific URL is received by the main information exchange system.

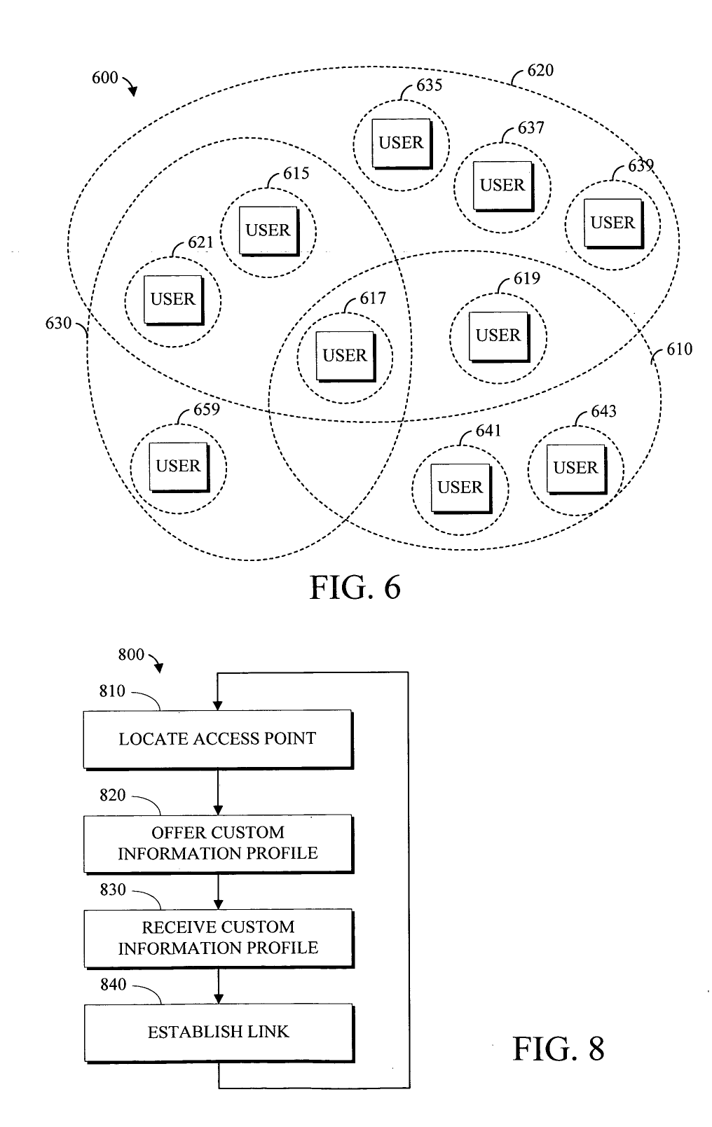

In the most preferred embodiments of the present invention, the URL with the embedded globally unique identifier may be used to display a web page containing publicly available user-selected information extracted from the custom information profile and/or additional user-selected information that may appear to anyone who “browses” the web page associated with a given URL. This becomes the user's access point or public door. Once created, and at the user's option, the web page can be made available for “spidering,” “searching,” or “crawling” by various commercial search engines and 'bots. Additionally, the URLs for multiple custom information profiles from different sources may be grouped together and listed on a single web page or multiple related web pages. This is somewhat analogous to grouping individual doors together to create a “street.” The various preferred embodiments associated with creating groups are further discussed in conjunction with FIG. 6.

The web pages associated with the system-generated and/or custom URLs may also be made available outside various system-level access control features so that they can be reached by anyone who obtains the URL for the web page and also to allow the various search engines to reach the web pages and include them in their respective search and index process. Those skilled in the art are familiar with the various techniques available for generating web site inclusion with the various search engines and these various techniques may all be suitably employed with the various preferred embodiments of the present invention.

Since one of the least expensive and most common ways of generating entries in the various search engines is provided by automatic indexing and linking, the most preferred embodiments for including the information associated with the various URL's available and/or visible in search engines will be to link the various individual URL's from the main information exchange system page and then link to the main information exchange system page from a plurality of other websites that the search engines already know about and which are already presently being crawled and indexed. This procedure may bring the automated search and index robots to the main information exchange site web page and, in turn, to the various linked sub-pages. Preferably, the information exchange system will extract dynamic information related to each user, such as access point information, from the master profile database and use this information to create a series of static web pages for easy crawling and indexing by the search engines. This can encourage additional links into the system as the links between external pages and the static web pages increase; the synergistic effect will move the static pages higher in the search engine results, making use of the system even more desirable.

While the previously described linking technique may be generally employed, several improvements are incorporated into the various embodiments of the present invention. First, in order to provide additional security for the users of the information exchange system, it is desirable that no visible or humanly-accessible listing of actual URLs be posted in any single location. This means that the most preferred embodiments of the present invention may restrict access to the list of URL web pages in general and provide access only for credible/reputable search engines. Access to the URLs may also be protected by various methods such as intentional obfuscation (e.g., “hiding” the URLs by placing the list of URLs in a less-than accessible location at the web site that is not easy to find) as well as limiting access to the list of URLs by verifying the IP address of any visitor prior to allowing the visitor to access the requested web page or pages. Additionally, once created, the master URL listings may be buried under multiple sub-domain page listings, including “error pages” that may further deter system abuse. In this way, only the permitted IP addresses for the search engine bots will have easy access to the master URL listings of the individual URLs.

By monitoring the traffic to the main information exchange web site, the permitted IP address list can be updated to account for normal changes in search engine operation and to accommodate new search engines as they are deployed. Additionally, as the main information exchange web site becomes more popular, it is anticipated that the owners and operators of the various search engines may eventually request access to the list of URLs for the purpose of directly searching and indexing the list of URLs for the individual URLs. The ability to restrict access to the list of URL web pages will generally not inhibit access to the individual user web pages in any way and the individual user web pages will usually remain directly accessible via the associated URL in the same manner as any other web page.

Additional methods of driving traffic to the web pages may include optimization techniques such as including information from the custom information profile in the web page title and meta tags associated with the web page where the custom information profile may be requested. Specialized search engine commands included in the source code for the web pages may also identify the pages as pages that are frequently updated by the information exchange system, thereby encouraging the automated search engines to return on a more frequent basis.

The decision to include public information on a door and to make that information available is a user-selectable setting that can control whether or not the information designated as “public” information is made available to search engines. If the user chooses not to make the public information available to search engines, the user may simply disable that setting. Once disabled, the link to that specific page may be removed from the list of URLs, and all search engine optimization features (key words in title and meta tags, etc.) associated with that page may be excluded. Additionally, an “automated search engine exclusion protocol” can be deployed, requesting that search engines limit the crawling and indexing of the pages.

This specific implementation of the present invention allows an individual to include user selectable search terms on a web page that are most likely to attract the specific target market or desired audience to the custom web page. For example, a custom information profile may include information such as high school attended, employment information, family connections, social or religious organizational membership, prior contact information (e.g., old e-mail address, previous employer, prior work address, prior phone number, prior school affiliation, etc.). Additionally, a user could set up a web page for classified advertising, dating profiles, product information, etc. By including this type of information, a user can selectively present the desired information to a tightly tailored audience and that information can exposed by simply allowing the current Internet search engines to index the web page, thereby enhancing the opportunity for the information to be found by individuals using the search engines. Additionally, the system-generated or custom URL can also be posted on other web pages (e.g., “blogs” and individual/corporate websites), printed on business cards, listed on product packaging, newspaper advertisements, etc. so as to make posting, searching for, locating and accessing the desired information relatively efficient and simple.

In addition to making it easier to find, re-connect, and remain in contact with other parties and/or individuals, the various embodiments of the present invention allow people to post contact related information without over-exposing themselves to unwanted contact and typical e-mail “harvesting” technologies. For example, if the globally unique identifier for an individual is NXN123, then a URL incorporating the globally unique identifier for this specific user can be constructed as follows: http://www.contactlink.com/door/nxn123. This becomes the access point for the user associated with NXN123. Using the same globally unique identifier to create an “e-mail address” for the same user may yield nxn123@contactlink.com. Or some similar e-mail address that incorporates the globally unique identifier.

It should be noted that this is not an e-mail address in the traditional sense. Rather, this becomes an alternative way of directing someone to the same access point because this e-mail address can be configured to generate an auto-response email message that would provide the following information, or some similar message to the e-mail initiator, “If you are trying to reach someone at an email address of the format “xxx123@contactlink.com,” please use your web browser to visit the web page of the format http://www.contactlink.com/door/xxx123.” This message, of course could also be customized to show exact correlation for a specific user. For example: “You just sent an email to nxn123@contactlink.com. To connect with this individual, please use your web browser to visit http://www.contactlink.com/door/nxn123.”

Similarly, using the same globally unique identifier as a telephone number yields, “602.555.1212, extension nxn123.” Alternatively, the phone number could be distributed as, 602.555:1212, “ask for NXN123.” Once again, this is not a traditional telephone number but is yet another way to redirect inquiries to the same access point. Once the number is dialed, a pre-recorded message can be played that states: “Thank you for calling a Contactlink redirection telephone line, if you were trying to reach a person at a particular extension, please use your web browser to visit http://www.contactlink.com and enter the desired extension in the appropriate place at the bottom of the web page. You may contact the desired person using this web page.” Similarly, the pre-recorded message may direct them to simply enter the globally unique identifier as a name, at the same http://www.contactlink.com web page.

In both of these examples, a web “door” or access point has been placed in front of the user's real e-mail address or phone number, thereby allowing them to freely give out an e-mail address or phone number where legitimate inquiries can be made, while still preserving an opportunity to qualify any request for information prior to actually revealing any PII or other sensitive information. An additional benefit of the messaging schema presented herein is that once the messaging schema is understood, it becomes possible to access the desired information directly by noting the presence of a globally unique identifier being used as an e-mail address or telephone number extension. Once understood, it will no longer be necessary to actually send an e-mail to receive instructions from the automated response or to call the phone number to be redirected to the access point. Instead, by simply noting the globally unique identifier and going directly to the associated access point, the addressing schema becomes more meaningful and direct.

Further, by selectively including descriptive yet non-personally identifiable information at the URL access point for a given web page (e.g., past employment, past contact information, high school, religious affiliation, etc.) individuals that do not have a personal web page can create a way for search engines users to locate and contact them. This powerful technique opens the way for many people to greatly increase the probability of being found via existing search engines. Finally, as the web pages are visited and as more links are created to the various web pages associated with the information exchange system, the proximity and weighting algorithms used by the various search engines will typically add additional relevance to the pages associated with the information exchange system, thereby enhancing the effectiveness of creating access points and associated URLs and linking to them.

Another option allowed by the present system is a “blind search” option that would be available directly through the system and accessed via the main system web page. This preferred embodiment of the present invention allows a user, even if they choose to limit the amount of information made available to third party search engines, could still choose to be reachable via the “blind search” function. In this embodiment, a searcher could enter various search terms which would search the full content of both master and custom information profiles (basically, the entire database of information or any relevant subset previously defined by the information owner), and simply receive a search result indicating whether there was one, none, or more than one match for the submitted search criteria. If no matches were found, the searcher could be encouraged to broaden their search criteria. Alternatively, if more than one match was found for the submitted search criteria, the searcher could be encouraged to further restrict or narrow the search criteria.

If a single match were found, the searcher would then be able to initiate a request for information by proffering their own custom information profile, but without receiving any initial visual confirmation of any additional information beyond the initial search terms that the searcher had previously submitted. This means that any URL or “door” belonging to the information owner would not be displayed. As with other embodiments of the present invention, the recipient of the request for information could evaluate the request and determine whether or not to release any information to the information requestor. This embodiment provides a way to search on private information without making it public, yet still offering the hope of a connection with the desired individual or entity.

Those skilled in the art will recognize that any and/or all of the searching methodologies described herein may be implemented in a “real time” fashion or as “stored searches” where the search criteria are saved and then the search is performed at a later date, on a manual, recurring schedule, and/or automatic basis. Additionally, it should be noted that the various search methodologies associated with the information exchange system could be accessed via an application program interface (API) and made available at third party websites. In this fashion, the searching could be conducted from any API-enabled website and the results would link back to the appropriate access point. This allows the methods of the present invention to be extended to other applications.

Further, those skilled in the art will recognize that other ways of directing traffic to the URL may include streaming direct feeds to third party search engines using techniques such as RSS, extended markup language (XML), and the like.

The update process of the preferred embodiments of the present invention is an improvement over previous implementations in a number of significant ways. Most notably, in the most preferred embodiments of the present invention, a “countdown timer” is employed to reduce or eliminate intermediate information update broadcasts. In these embodiments, the countdown timer controls the actual broadcast of updated information by grouping all intermediate information updates into a single information update that is broadcast after a selectable and adjustable predetermined period of time.

For example, if the countdown timer is set for a 10-minute period, all information updates made by a user within 10 minutes of any previous update are “staged” or grouped together and held for the 10-minute period. Then, at the end of the 10-minute period, provided no additional updates have been made, the amalgamated information update is released for distribution to any connected individuals or entities. Whenever the user updates any information in the information profile, the countdown timer is “reset” to the waiting period for the duration specified. This is a continual activity that ensures no updates are actually communicated until the period of the countdown timer has expired. The actual time period for the countdown timer is adjustable and can be set to intervals appropriate with and in conformance to the use pattern for any given user. This allows a user to repeatedly update and modify their information without generating multiple intermediate information updates to connected parties. In the most preferred embodiments of the present invention, the countdown timer is integrated into database access application 224 of FIG. 2.

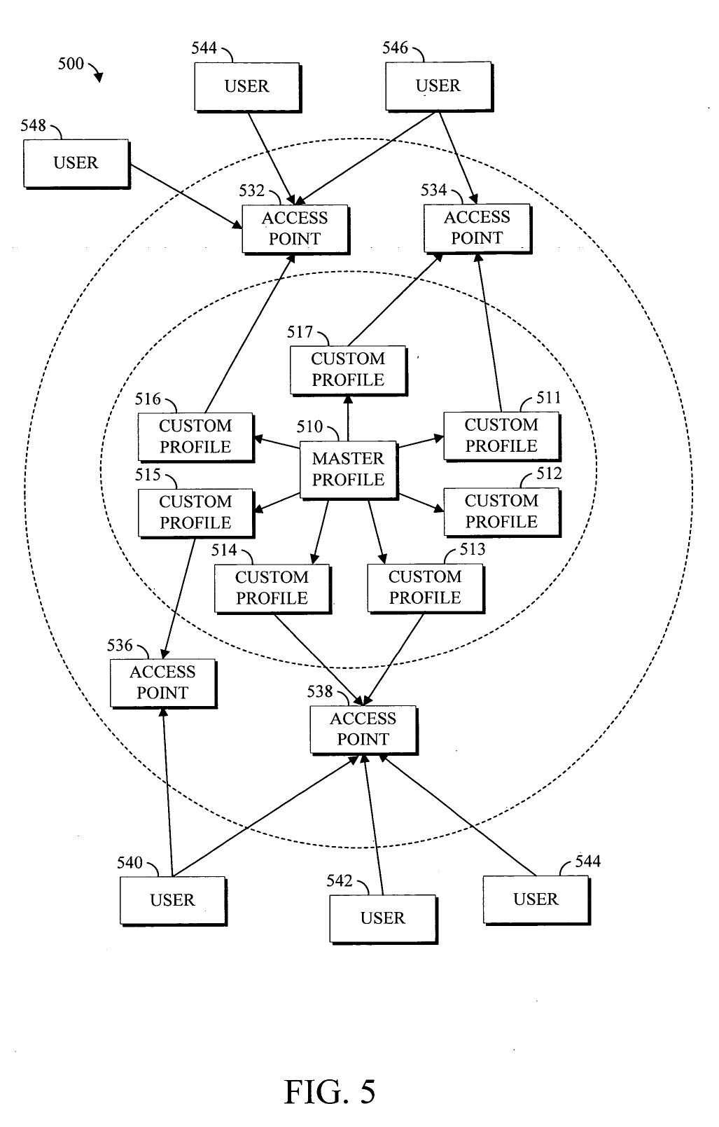

Referring now to FIG. 5, a schematic diagram of the relationship between custom information profiles in an information exchange system and the process of granting access to the associated custom information profiles is set forth. As shown in FIG. 5, a single master information profile 510 has been used to generate custom information profiles 511, 512, 513, 514, 515, 516, and 517 by using a process substantially similar to that previously explained in conjunction with FIG. 4. Additionally, access points 532, 534, 536, and 538 are configured to provide access to one or more custom information profiles 511-517 for one or more of users 540, 542, 544, 546, and 548.

Access points 532-538 are representative of various URLs, reached by different methods, whereby an individual or entity might gain access to one of custom information profiles 511-517. After reaching an access point 532-538, the user is asked to present their own custom information profile and request access to the desired information. For example, access point 532 may represent a uniform resource locator (URL) for a web site where a specific custom information profile 517 may be provided. As shown in FIG. 5, user 544 and 546 may each be presented with a different custom profile (one of 511 516, 517), depending on the decisions made by the owner of the information being presented as based on the credentials of the person or entity requesting the information. It should be noted that a given custom information profile may contain all or some or none of the information from master information profile 510. Additionally, a message or note may be associated with a custom information profile when two users undertake to exchange custom information profiles. Once two individuals or entities have agreed to exchange custom information profiles, they are “linked” or “connected” to each other.

Additionally, in the most preferred embodiments of the present invention, the information available to the information requester in enhanced after the connection is made between the two users. For example, prior to making a connection, the information requester has access to the public profile information displayed at the access point. Upon making a request, certain information is available from the user's respective custom information profiles and any request specific message. Then, after a request has been authorized, additional information is made available via the custom information profiles that are exchanged.

While the initial connection established between any two users is defined by a specific access point for each user and a specific card exchanged by each user, either user can redefine their access point and substitute a new card for the card originally exchanged. At any point in the future, either party may update the information associated with their linked information profiles and the other party will automatically receive the updated information. Further, either party can elect to “break” the link at any time, thereby severing the relationship. Those skilled in the art will appreciate that by exchanging the same custom information profile with multiple parties; all linked parties can receive updated information by simply updating the relevant custom information profile.

In yet another preferred embodiment of the present invention, each registered user is provided with one or more visual status indicators that display the status between them and any other system users. This means that in addition to viewing the information associated with a given user, the connection indicators may display every possible status that may exist between the viewer and the other members including “unconnected,” “incoming request,” “outgoing request,” and “connected.” When arriving at an access point, the visual status indicator can provide an immediate indication of the status for the system user that created the access point. The most preferred embodiments of the present invention will generally allow a user to stay “logged into” the system by including a “cookie” on the hard drive of the user, identifying who the user is. The cookie can be examined whenever the system user visits an access point and the status of the user with the owner of the access point can be established and displayed.

It should be noted that changing the view or display relative to the connection status between users is substantially different than the common approach of changing the display based on the user's relationship to the system. Instead of merely changing the user's present view based on whether the user is a member of the system and whether or not the user is logged into the system, the user's view of other system users is based on the status of the connection that exists between the viewing user and the other system users. Accordingly, when arriving at access point 534, the visitor will, if a member of the information exchange system and logged into the system, be able to ascertain their connection status relative to the owner of the information presented at access point 534.

Additionally, as previously explained, access point 534 may represent a URL that has been accessed by dialing a phone number that has a recorded message directing the listener to a the URL associated with access point 534, which in turn provides access to custom information profile 517 or custom information profile 511. Access point 538 may represent a URL for a web page displaying the results of a search performed by a standard search engine.

Once users 540, 542, and 544 arrive at access point 538, they may identify themselves by presenting their own custom information profile and, depending on the decision made by the owner of the information contained in master information profile 510, they may be presented with custom information profile 514 or custom information profile 513, any other custom information profile, or no information profile at all, depending on the decision made by the owner of the requested information. Additionally, custom information profiles 513 and 514 (or some other custom information profiles) may be proffered simultaneously and combined into a single new custom information profile. It should be noted that although specific custom information profiles are shown as associated with specific access points for purposes of illustration, in the most preferred embodiments of the present invention, any custom information profile may be exchanged via any access point.

It should be noted that some access points may be configured as automatic access points. In this embodiment of the invention, a given access point may be configured to provide a pre-determined custom information profile to any requester that arrives at a predetermined access point who proffers a valid custom information profile of their own. In this way, a user may provide a specific URL for a specific access point to selected individuals, thereby providing generic information to any party that wishes to retrieve the custom information profile from that pre-determined access point. Once again, after the custom information profiles have been “linked,” or exchanged, either party may update their information with the knowledge that the updated information will be available to all linked parties.

Additionally, a user may create a security or access code for certain access points or URLs. In this specific embodiment of the present invention, any party requesting information at a certain access point may be presented with the opportunity to provide the access code associated with that access point. If the visiting party provides a valid custom information profile and the proper access code, then a pre-determined custom information profile may be provided. This embodiment of the present invention allows a higher level of control for accessing information because only trusted parties, who have the appropriate access code, can gain access to the information.

The above-mentioned access code may be provided as part of the URL for that specific access point and, upon reaching the web page, the exchange of custom information profiles can happen automatically upon presentation of a custom information profile by the visitor to that specific web page.

In at least one preferred embodiment of the present invention, once a request for information has been received through an access point, the owner of the information can determine which access point was used to gain access and may evaluate the request and, by reviewing the proffered custom information profile in conjunction with the access point, be able to ascertain whether or not a request for information should be granted to the requesting party. The owner of the access point can then determine, on a case-by-case basis, which of their own custom information profiles to exchange and “link.” Additionally, it is possible to attach a note or message to a custom information profile, thereby adding additional information that can facilitate the decision-making process.

In the most preferred embodiments of the present invention, the owner of the information may decide to make any one or none of the custom information profiles available upon request. Additionally, the owner of the information may elect to create a brand new custom information profile in response to a given request. In any case, once the owner of the information provides a custom information profile to a requester, a “connection” is established between the information requester and the information provider and each parties has access to the other party's proffered custom information profile.

Once a connection between a requester and a given custom information profile has been established, the owner of the information displayed in conjunction with the custom information profile can update the information associated with the custom information profile without any intervention on the part of the user who initially requested access to the information associated with the custom information profile. This means that once two individuals or entities exchange custom information profiles and become “connected,” any future updates to either custom information profile may be automatically made available to the respective parties via the previously established connection.

In this way, instead of requesting updates from every other user in the system, each user can simply maintain their own information and it can automatically be made available to all connected parties. It should be noted that, in the most preferred embodiments of the present invention, each user of the system, if and when connected to another user of the system, is connected on a “one-to-one” basis, after both parties have agreed to exchange a custom information profile. In this manner, there are no unexpected or unwanted connections made and no information is released without the explicit authorization of the party that “owns” the information.

The nature of the automatic updates for the linked information can be provided in many ways. For example, a user may wish to be notified by e-mail whenever a linked custom information profile is updated. Alternatively, for personal contact information, a new “v-card” or similar electronic data file may be transmitted. Those skilled in the art will recognize that many other notification methodologies are possible. Any or all such methods may be adopted in various preferred embodiments of the present invention.

Referring now to FIG. 6, a schematic diagram 600 for grouping users into access groups in accordance with a preferred embodiment of the present invention is depicted. Schematic diagram 600 includes users 615, 617, 619, 621, 641, 643, 635, 637, 639, and 659. Additionally access groups 610, 620, and 630 are also represented. As shown in FIG. 6, each user belongs to one or more access groups. For example, users 617, 619, 641, and 643 belong to access group 610. Similarly, users 615, 617, 619, 621, 635, 637, and 639 each belong to access group 620. Finally, users 615, 617, 621, and 659 each belong to access group 630. It should be noted that each user may belong to one or more access groups. As shown in FIG. 6, user 617 belongs to access groups 610, 620 and 630 while user 659 belongs only to access group 630.

By grouping users into access groups, controlling access to information can be greatly simplified. For example, assuming access group 610 represents a professional organization and user 617 is a member of that profession organization, user 617 could create a custom profile for the members of access group 610. In this fashion, each member of access group 610 would receive the same data relative to user 617 when and if they join access group 610. However, since user 617 is also a member of access group 630, and since access group 630 represents a separate organization, user 617 may also create a custom profile for access group 630, displaying the same or, more likely, a different set of data than the data contained in the custom profile for the members of access group 620. User 617 can choose to share the custom profile with the members of access group 630 universally or on a case-by-case basis.

The various preferred embodiments of the present invention provide for multiple groups to be defined. The owner of the information for a given custom information profile can define a “group” by simply exchanging the same custom information profile with multiple recipients. Then, the entire group (sample groups may include customers, family, employees, etc.) can simultaneously receive information updates by changing the information for the underlying previously exchanged custom information profile.

Alternatively, various users may decide to affiliate themselves with a URL for a group access point where a visitor may access multiple individual access points, where each available individual access point is related to a different person or entity (sample groups of this nature may include alumni organizations, bowling leagues, etc.). By placing themselves into these types of groups, it can be relatively easy to reach members of the group via a common group access point. According to the various preferred embodiments of the present invention, the ability to join a given group may be controlled by a system or group administrator (“private group”) or, alternatively, may be opened up for anyone to join the group as they see fit (“public group”).

Additionally, as previously explained various users can create individual access points and voluntarily post the URL of their individual access point alongside the URLs of other individual access point for the group. In this fashion, a single web page for a particular group or organization may have links to the URLs for the individual members of that group. Once a person finds the group URL, they can then selectively access any or all of the individual URLs and the individual access points associated with each separate individual. As before, a requester of information can then browse to the desired link for a given member of the group and proffer their own custom information profile, requesting access to the custom information profile associated with a given URL for an individual.

Regardless of how someone arrives at a given URL, they may have the opportunity to view the information displayed at the web page associated with the URL and decide whether or not they wish to exchange custom information profiles with the user associated with that web page. In the case of “auto accept” URLs, if the visitor proffers any custom information profile at all, they may automatically receive a pre-designated custom information profile and the two custom information profiles can be “linked.” It should be noted that the auto accept code may be provided at the group or individual level. Accordingly, any individual that becomes a member of the group may receive one or more custom information profiles by offering their own custom information profile to the group or to members of the group.

In an alternative preferred embodiment of the present invention, a custom security code may be required, in addition to the proffering of a custom information profile, in order to receive a custom information profile in return. Upon presenting the appropriate code and a custom information profile, a pre-designated custom information profile may be proffered and linked. Finally, a given URL may use a combination of the auto-accept method and the security code method, with either a predetermined or configurable “order of precedence” rule being employed to control which custom information profile is actually proffered to a given visitor. By employing combinations of these various techniques, in addition to the standard “case-by-case” methodology, highly customizable information presentations can be created and offered for consumption by highly targeted messages.

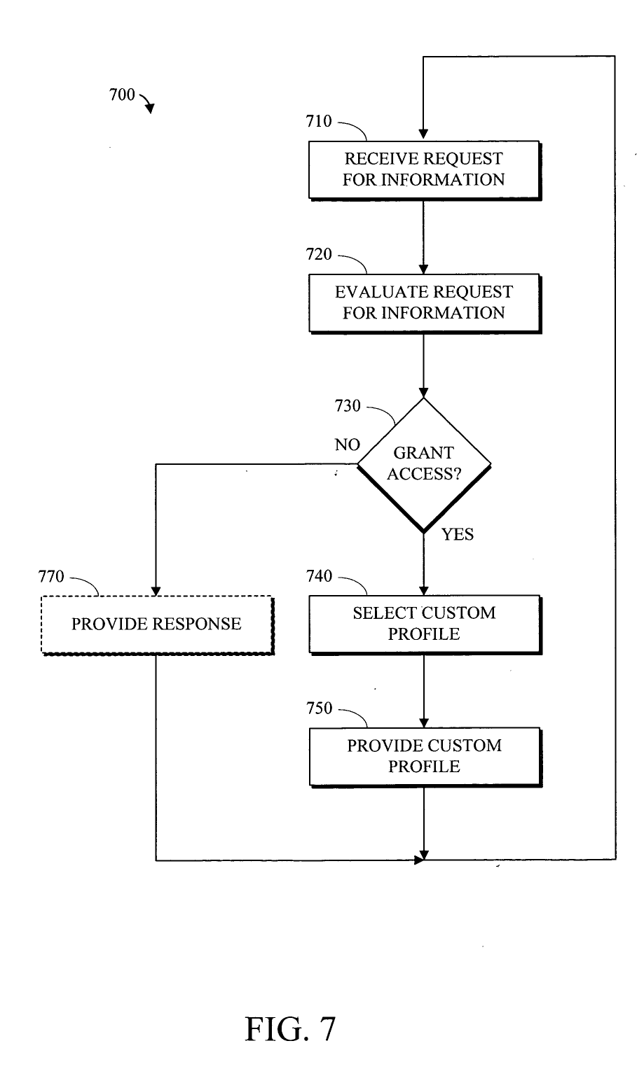

Referring now to FIG. 7, a method 700 for granting access to information in accordance with a preferred embodiment is depicted. As shown in FIG. 7, a user who has made their custom information profile available may, on occasion, receive a request to provide information (step 710). In the most preferred embodiments of the present invention, the request for information may be accompanied by a custom information profile presented by the party requesting the information. Additionally, the request for information may also include additional information such as a note or message describing the reason for the request, a description of the access point whereby the party requesting the information entered the system, time the request was made, etc. The request for information may be provided by means of an e-mail message sent to the user by the system or some other notification methodology such as adding a flag to the web page used to display user account information. Alternatively, the request for information may be integrated into existing contact management software such as Outlook Express, etc.

Upon receiving the request for information, the user can evaluate the request for information (step 720). This evaluation process may involve reviewing the custom information profile for the party requesting the information as well as the access point whereby the party requesting the information entered the system. These data elements will typically provide the user with the ability to determine whether or not the information request is a legitimate request and, accordingly, whether or not to provide access to the requested information (step 730).

If the user decides to grant access to the information (step 730=“YES”) then the user may either supply access to an existing custom information profile or create a new custom information profile for the party requesting access to the information (step 740).

Finally, the user can provide the selected custom information profile to the party requesting access to the information (step 750). It should be noted that providing access to the requested information means creating a “link” between the user and the party requesting access to the information. After a link has been established, it may be “broken” by either party at any time. However, while the link is active, any changes made to the custom information profile provided by each party to the other party can be updated in response to any changes made by the party controlling the information contained in the custom information profile.

If the user decides not to provide access to the requested information (step 730=“NO”), then the user or the system may optionally provide a response indicating that access to the requested information will not be provided.

As shown in FIG. 7, it is anticipated that multiple requests for information may be received over a period of time. In the most preferred embodiments of the present invention, the requests are stored in a “queue” and may be acted on by the user as the user sees fit. The user may accept the request, decline the request, postpone responding to the request, etc. Once acted upon, the request can be moved to another queue and reviewed at some time in the future. The various queues (pending, declined, accepted, etc.) are merely indicators to show the status of any and all connection requests and may be implemented in a single queue with multiple views and/or visual status indicators or, alternatively, as multiple disparate queues. Additionally, a separate queue may be maintained to indicate a previously made request, as of yet unanswered, that has now been “withdrawn” by the original requester. Those skilled in the art will recognize that these examples are merely representative of many other similar functions that may be provided for reporting on the status of each request for information.

FIG. 8 is a flow chart for a method 800 of requesting access to information in accordance with a preferred embodiment of the present invention. As shown in FIG. 8, a user may locate an access point to the system via any method known to those skilled in the art (search engine, printed publication, etc.) (step 810). As previously explained, the access point may be a web page identified by a system-generated URL containing a globally unique identifier that has been made available to a Internet search engine or otherwise posted on a web page, a URL containing a globally unique identifier printed on a business card, a URL containing a globally unique identifier provided via a telephone number with identifying extension, etc. Those skilled in the art will recognize that this methodology can be extended to other messaging mediums as well (television advertising, instant messaging, billboards, etc.).

In any case and however reached, the access point is most preferably a web page identified by a URL containing a globally unique identifier available on the Internet that can be accessed via any standard web browser. Once the user reaches the access point, the user may proffer a custom information profile (step 820) for review by the owner of the access point. After evaluation, the requester may receive a custom information profile in response (step 830). As previously noted, a custom information profile may be provided in response to a request for information or no custom information profile may be provided in response to a given request for information. If a custom information profile is returned, then the two parties are linked (step 840) until such time as one of the parties elects to break the connection. As previously explained, as long as the custom information profiles remain linked, any changes to the information associated with the custom information profiles can be automatically updated by the parties.

Those skilled in the art will recognize that the various preferred embodiments of the present invention can alternatively be described by means of a simple “door” and “card” analogy. Basically, the various preferred embodiments allow each system user to create one or more custom “cards” containing user selectable information. Additionally, each system user can create one or more “doors” (web pages accessible via URLs) and put any type of identifying information on the door that the user deems advisable. These various custom cards are then exchanged with other information exchange and update system users, as desired. An exchange of cards only takes place when someone “knocks” on a door and the individual or entity on the other side of the door makes a decision to exchange information with the individual or entity on the outside, based on the information contained on their respective “cards.” In this fashion, true permission-based contact exchanges are performed.

As previously explained, each exchange of cards by two information exchange and update system users provides an on-going connection or “link” between the cards for the individuals or entities that exchanged the cards. Additionally, once cards have been exchanged, the information associated with the exchanged “cards” is automatically updated by the system whenever the owner of the information updates the information on their card. This approach can be especially valuable in the exchanging of contact information between individuals.

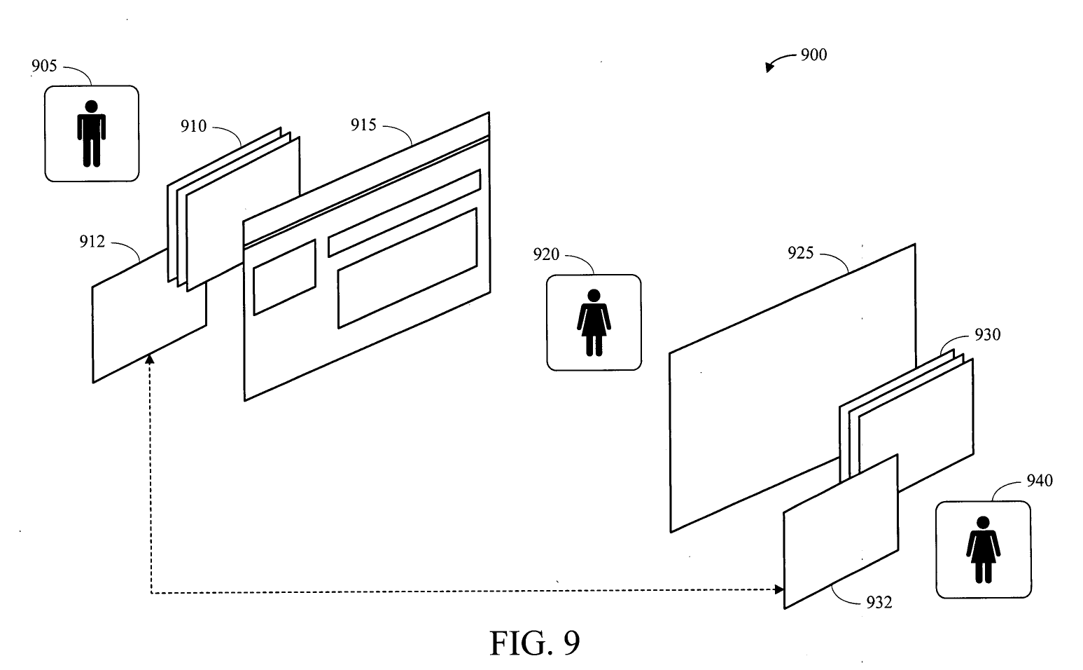

Referring now to FIG. 9, a schematic diagram of a contact information management system 900 in accordance with a preferred embodiment of the present invention is depicted. FIG. 9 represents the most preferred embodiment of the present invention. This particular embodiment of the present invention is a specific application of the more general information exchange system of FIG. 1 and is configured to provide a simple and efficient way for individuals to maintain and update their contact information and to exchange contact information with desired groups or individuals through the contact information management system 900. Users 905, 920, and 940 are representative of any individual or person that has access to contact information management system 900. Web pages 915 and 925 are representative of access points that can be accessed by a standard web browser via entering an appropriate URL.

As shown in FIG. 9, users 905, 920 and 940 all have access to various portions of system 900. In this case, users 905 and 940 are already registered members of system 900 and have established their membership accounts with one or more custom information profiles. In the case of user 905, custom information profiles 910 and 912 are available for exchanging with other users of system 900. In the case of user 940, custom information profiles 930 and 932 are available for exchanging with other users of system 900. It should be noted that user 905 and user 940 will preferably have established at least two custom information profiles, a public profile and a private profile. The public profile will usually contain any information that the owner of the information has determined may be made available in various ways to users of system 900 and the private profile usually contains information that is not released without specific authorization.

User 920 has not yet joined system 900 as a registered user and, accordingly, does not have any custom information profiles to exchange with other users of system 900 and cannot access any custom information profiles belonging to user 905 or user 940. However, this does not mean that user 920 cannot access any of the information contained in system 900. For example, user 920 can use any web browser to navigate to web page 915 and/or web page 925; thereby viewing any and all public information displayed at web pages 915 and 925. Additionally, upon reaching web page 915 or web page 925, user 920 may elect to register with system 900, thereby joining system 900 and creating one or more custom information profiles to exchange with other users of system 900. As previously explained user 920 may have been directed to the URL for web pages 915 and 925 by some type of notification or message (e.g., a phone message, e-mail, instant message, etc.) or by searching in some type of Internet search engine.

In the case of users 905 and 940, they are both registered users of system 900 and have previously exchanged custom information profiles with each other, creating a link between them. As shown in FIG. 9, user 905 has exchanged custom information profile 912 with user 940 and user 940 has exchanged custom information profile 932 with user 905. As previously explained, whenever either user updates the information contained on their respective custom information profile, the other user is provided with the updated contact information.

Once user 905 or 940 have become registered users of system 900, they may wish to search system 900 for other users, known or unknown. Although various search methodologies are available, several unique applications of the system 900 may be formulated. For example, given that users 905 and 940 have both provided certain information about themselves to system 900, that information may be used to enhance the results of any search performed in system 900. In this example, if user 905 is searching for another user named “John Smith,” it is possible that there may be more than one user with the name “John Smith” in the system. Accordingly, the search results may return a multitude of potential matches. This problem may be further exacerbated by the situation where only the first or last name of the person is known. Additionally, user 905 may be searching for another user based on information other than the user's name.

For example, user 905 may be trying to locate another user that lived previously worked for a certain company. In this case, the list of users that have worked for this company may be extensive, yielding a long list of potential candidates. User 905 would then to begin the laborious task of parsing all of the results in an attempt to locate the desired user. This process can be simplified by using the information contained in the various user information profiles to “rank” the results of user 905's search. The correlation may be made by using any and/or all of the information known about the users, including common connections with other users, group memberships, keywords, prior employers, colleges, etc.

For example, an algorithm may be deployed in conjunction with system 900 where the following criteria are used to further stratify the results of the search for “John Smith” performed by user 905.
1) A user named “John Smith” was in two groups that user 905 also belonged to in;
2) A user named “John Smith” was a member of three other groups that had a strong group correlation with the groups from item #1;
3) A user named “John Smith” was in four other Groups that had strong Group correlations with other Groups of which user 905 was also a member
4) A user named “John Smith” has two people in common with user 905 as direct connections.
5) A user named “John Smith” has three other people in common at the two degrees of separation level with user 905.
6) A user named “John Smith” has four keywords in common with user 905 in their respective custom information profiles.
7) A user named “John Smith” has five keywords in common with user 905 on their respective private profiles, etc.

Those skilled in the art will recognize that each of these factors may be used in an algorithm to compare various correlations that exist between user 905 and the other users named “John Smith.” By evaluating the various correlations and ranking them by using the algorithm, it is most likely that the desired “John Smith” can be elevated in the search results and found more easily.

An additional feature in the most preferred embodiments of the present invention provides a visual status indicator that displays the connection status between any two system users. This is simply a visual review of the state of connection (or lack thereof) that currently exists between the viewer and the owner of the web page where the information that is being displayed. The connection indicators may display every possible status that may exist between the viewer and the group member including “unconnected,” “incoming request,” “outgoing request,” and “connected.” For example, if user 920 browses to web page 915, user 920 will typically only see the public information posted at web page 915. This would be the same view of web page 915 that would be displayed for a search engine that would be “crawling” web page 915. However, if user 940 browses to web page 915, user 940 will typically be able to see the public information and, depending on the permissions granted by user 905, may also be able to view additional information including a status indicator that displays a “connected” status for users 905 and 940.

As previously explained, user 905 and 940 each controls their own information and make custom information profiles available to other user as they see fit. Once either user decides that they no longer wish to share their information, they can “break” the connection with the other user. However, in at least one preferred embodiment of the present invention, user 905 may provide a “sidelink” to another user (other than 940) using custom information profile 932 previously provided to user 905 by user 940. As before, if user 940 updates custom information profile 932, then the other user would also receive the update via the sidelink connection with user 905. However, once user 905 or user 940 decides to break their connection, then the sidelink would also be broken and the other user would no longer receive any additional information regarding custom information profile 932. It is anticipated that sidelinks of sidelinks can be established by and between various users of the system. The number and availability of sidelinks may be user or system configurable and defined by the number of “levels” allowed. For example, a user may configure each custom information profile so as to deny authorization for exchanging their custom information profiles as sidelinks. Alternatively, the user or the system may allow sidelinks that are “one level” or “two levels” deep.

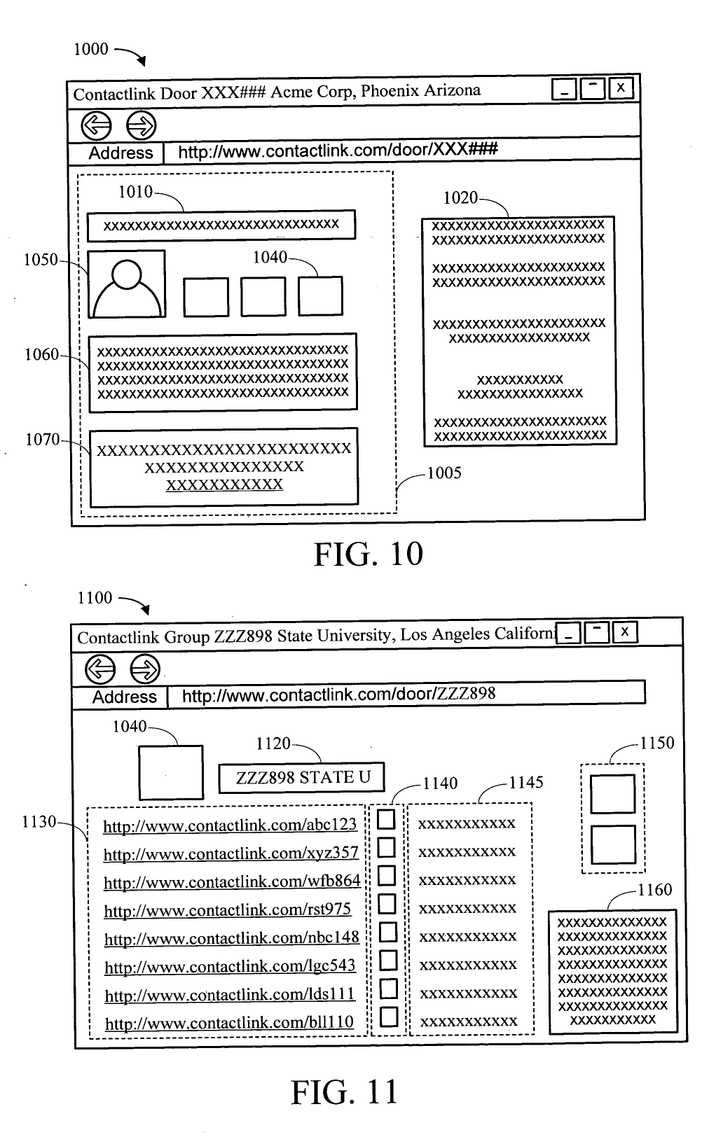

Referring now to FIG. 10, a schematic representation of a sample web page or “access point” 1000 for an individual registered user of a contact information management system 900 in accordance with a preferred embodiment of the present invention is depicted. As previously explained, web page 1000 is the web page for a registered user identified by a URL including the system-generated globally unique identifier “XXX###.” As shown in FIG. 10, the globally unique identifier XXX### is a portion of and contained within the URL for web page 1000. By including the URL with the associated globally unique identifier on business cards, letterhead, promotional pieces, etc., visitors can be directed to the web site for the registered user identified by the URL containing the globally unique identifier XXX###. Those skilled in the art will recognize that the format “XXX###” is merely illustrative of one type of globally unique identifier that may be employed. Other identifying schema may be suitably employed in the various preferred embodiments of the present invention.

As shown in FIG. 10, various types of identifying information can be displayed in one or more information fields 1005 on web page 1000. For example, the name of the user may be contained in information field 1010. Similarly, a photo of the registered user associated with the globally unique identifier XXX### may be displayed in the graphic 1050. If the registered user belongs to one or more public and/or private groups, the user's group affiliations may be displayed by one or more group affiliation identifiers 1040. Each public and/or private group may be viewed as an electronic representation of an affiliation with a given group of individuals who have chosen to align themselves with each specific group. For example, groups may be affiliated with an alumni association, union group, social club, service organization and the like. Other types of groups may be related to hobbies, professions, families, and the like. Group affiliation identifiers 1040 may take the form of text identifiers, logos, combinations of text and logos or the like and may be “hyperlinks” to other group-related web pages that provide additional information about the group. By clicking on a given group affiliation identifier 1040, the web browser can be re-directed to a web page that provides information about the group associated with the group selected group affiliation identifier. Group web pages are discussed in further detail in conjunction with FIG. 11.

Information fields 1060 and 1070 may display identifying information from the user's public profile or any other information that the owner of the information deems relevant and appropriate for public display at web page 1000. Further, the information contained in information fields 1060 and 1070 may also be included in the information made available to various search engines. In addition to information fields 1005, web page 1000 will preferably display system instructions 1020. System instructions 1020 are provided to assist visitors to web page 1000 in accessing and using the system. For example, system instructions 1020 will typically provide instructions on how to exchange information with the user identified by web page 1000, including instructions on joining the system.

Referring now to FIG. 11, a sample web page 1100 for a group in accordance with a preferred embodiment of the present invention is depicted. As shown in FIG. 11, the group associated with web page 1100 is identified by the globally unique identifier “ZZZ898.” As with each individual web page 1000 of FIG. 10, various information fields 1120 and 1160 may be provided to identify the group affiliated with web page 1100. In the most preferred embodiments of the present invention, each member of the group associated with web page 1100 may be listed by their URL 1030 and each URL 1030 will serve as a “hyperlink” to that user's individual web page. If desired, each member may also have a thumbnail image 1140 to provide a visual representation of the member.

The most preferred embodiments of the present invention may also include additional identifying information in information field 1145. Information field 1145 may contain identifying information such as the user name, nickname, etc. Those skilled in the art will recognize that the sample group presented herein is merely illustrative in nature and that many other groupings and group affiliation based web pages are possible. For example, it is not necessary to include the entire URL for each user on the group web page. In some preferred embodiments of the present invention, it may be desirable to include only the globally unique identifier for each individual and/or their publicly available user information.

In addition, the most preferred embodiments of the present invention may also provide one or more associated group identifiers 1150 on a group web page. Associated group identifiers 1150 are most preferably provided as “hyperlinks” to other group-related web pages in the system for groups that are logically related to the displayed group. For example, a user may have graduated from a university and, accordingly, may choose to display a group affiliation identifier 1040 to identify the university that was attended. When clicking on the group affiliation identifier 1040 for the university, the web browser may be redirected to the web page for the university. The web page for the university, in turn, may display one or more associated group identifiers 1150 to direct traffic to the alumni association, the university sports booster club, etc.

In this manner, affiliated groups and individuals can be quickly and efficiently identified and located. Using the “door” and “card” analogy, a group can be viewed as a “street” from which multiple doors can be accessed. A user can choose to list the URL for their individual web page on the group web page and may also list the URL for the group web page on their individual web page. As previously explained, once a user arrives at any given access point, they may request additional information by proffering a custom information profile for review by the owner of the web page being visited.

Additionally, once a number of users have established their affiliation with various groups, other benefits can be obtained. For example, the system can make recommendations as to which groups may be of interest to a given user by examining that user's affiliations and comparing them with other users who share one or more common affiliations. Further, probable affinities between any two system users can be made by noting the number of identical or similar group affiliations that may be shared by the users, allowing like minded individuals to connect with each other. This will be especially useful in “re-connecting” with former acquaintances whose contact information is no longer up to date or available. Similarly, the system can observe the behavior of the users as they align themselves with the various groups. Then, based on correlation and statistical analysis, the relationships between various groups can be deduced by the system and relations between the groups can be calculated and weighted to provide a hierarchy or directory of groups with interconnections between the groups noted.

Since then individual behavior of the users can be used to define groups, the identity of the groups in the system are not limited by any overt user constraints. Once various group affiliations have been established, group correlation, as extrapolated from user behavior, can allow the system to generate “related group” affiliations on the fly, thereby allowing users to browse related groups so as to locate desired groups and/or align themselves with desired groups, all without any overt act on the part of any specific user or users. Once the desired groups have been located, it can make the task of locating an individual member of that group much easier. Search results can be further enhanced by using group, people, and place profiles associated with groups as derived from the information associated with both the groups and the individual members of the groups. Since the search results can be correlated by the activity of the users, the analytical group affiliations can provide additional opportunities to efficiently and effectively “re-connect” with former friends and acquaintances. This feature also allows for the efficient ranking of search results where more than one possible result is returned. By noting the group affiliation(s) of the searcher and matching those affiliations with the individuals returned by the search, the possible matches can be ranked by strength of group correlation between the searcher and the individuals represented in the results of the search.

A public group web site may be visited by anyone who chooses to browse to the URL associated with the public group. As shown in FIG. 11, the web page of a public group has a unique address, name/title, and description. This identifying information is created and entered when the group is first created and will usually not change after being created. As with individual URLs the group address could be a system-assigned address and then include an option for adding a custom address as well. A group is typically created by a user and the user is automatically designated as the first member of the group when they create the group. After creation, any user may choose to leave the group at any time. Each public or private group, and the associated identifying information for that group, can then be made available to various Internet search engines and, as with individuals, the group may be located via the search engines by including the public terms available at the group site in the appropriate search.

The web page for each group may also provide a list view of the members belonging to the group. The list view may also incorporate certain public profile information associated with each user. The group list may be sorted and displayed in alphabetical order, numerical order, or other order as selected or initially indicated by the owner of the group, or as determined and reordered by the user viewing the group web page. The most preferred embodiments of the present invention may also provide a visual special status indicator next to each name listed in the group view to indicate the state of connection (or lack thereof) that currently exists between the viewer and each group member. The connection indicators will typically display every possible status that may exist between the viewer and the group member including “unconnected,” “incoming request,” “outgoing request,” and “connected.”

Given the overall information exchange and update system framework created by the various preferred embodiments of the present invention, additional variations will become clear to those skilled in the art. For example, an entire messaging system can be built using the methodologies contained herein. Using various preferred embodiments of the present invention, it is now possible to contact any person in the information exchange and update system via e-mail redirection, instant messaging, internet search engines, telephone, etc.

For example, the information exchange and update system could be deployed as a “white-list” system of people that have already exchanged the appropriate contact information and permissions with each other, so messages could be passed directly through the information exchange system. By providing all or substantially all of the necessary personal contact information for connecting to the desired universe of contacts to the system, the information exchange system could function as an efficient new communications medium, relatively free of spam and other third party intrusions. This is especially possible for private groups where permission to join is required.

With this preferred embodiment of the present invention, a “pop-out” message or reminder could be used to alert the system user that there are messages waiting for their review in the information exchange system. A message could be in the form of an email, phone call, instant message, etc., notifying the user that there a message has arrived in the information exchange system. This could also be implemented by forwarding the actual message itself to the intended recipient. One unique benefit of this type of messaging system is the flexibility it provides to the users. For example, with a typical e-mail messaging system, once the e-mail leaves the system, the content is fixed and the sender of the e-mail loses all control over the message and its delivery. In contrast, the present system stores the message internally and notifies the message recipient that a message is waiting for them. Prior to the time they respond and retrieve the message; the sender of the message may change the content of the message.

As yet another specific example, it is now possible to create a “personal information page” or PIP. With the ever-growing amount of information available on the Internet it has now become possible and, for some individuals, desirable, to do “vanity searches” of the Internet, using search engines such as Google and Yahoo to try and locate themselves on various web pages and in various links. In at least one preferred embodiment of the present invention, a user could create an access point or web page using a PIP URL that includes the name or identifying information for a third party that a system user wishes to locate or that the user wishes to be contacted by. As previously explained, the publicly available information associated with the PIP web page can then be submitted to various Internet search engines. Then, when the desired third party arrives at the PIP access point, they can make contact with the creator of the PIP access point, if desired. This may be accomplished by simply providing a link from the PIP access point to the web page associated with the creator of the PIP web page.

In this embodiment, a PIP web page would be created for the third party that is sought and made available to the various Internet search engines in the manner previously described. It should be noted that while it is possible to include multiple people on such a page, the most preferred embodiment would allow creation for a single third party only. The PIP would be limited to displaying information about the person that is generally publicly available only, so as to prevent any unwanted disclosure of personal information related to the sought-after third party. Standard information fields might include such things as First Name, Last Name, company/organization (which would thus encompass such possibilities like name of church, softball league, high school, fraternity, etc.), City, State/Province, and Country.

After providing this public information, a custom web page, with associated URL, would be created by the information exchange and update system and the web page containing the information would be made available to the various Internet search engines. Then, when the third party searches for their name, they can be directed to the URL for the PIP and decide if they wish to exchange custom information profiles with the individual or entity that created the PIP. In this way, it may be possible to “re-connect” with former associates, lost friends, lovers, partners, etc. This process is similar to “fishing” using customized “bait” to attract a specific audience to a web page. In this fashion, very highly targeted third parties can be attracted to create the desired connections. This is especially useful for contacting third parties who do not even necessarily know they are being searched for.

Those skilled in the art will appreciate that the various preferred embodiments of the present invention provide a protected environment for each and every individual or entity that is part of the overall information exchange system. This feature allows each individual or entity to retain control of their information and determine whether or not to allow access to their information. While described herein primarily in the context of exchanging and updating contact information, those skilled in the art will readily recognize that other applications such as disseminating product information, updating and exchanging customer information and the like are also possible with the various preferred embodiments of the present invention. It is also important to note that the protections provided to users of the preferred embodiments of the present invention make it far less likely that unwanted information releases will occur.

This is in contrast to other known contact update systems that provide system users with no protection at all or that provide protection for all or some members of a group (be it around an alumni directory or around those individuals that may be “four degrees of separation” from you, etc.). While this previously used approach theoretically protects the individual from others outside the group, once someone has joined the group, the information belonging to those inside the group is potentially exposed. This is highlighted by the proliferation of so called “six-degrees” of separation groups that are, by definition, groups defined from the perspective of each participating individual, centered on them and going out to a proscribed network distance—usually four degrees. Of course, while the various protocols that define how the other people within the group can contact other individuals within their “group,” some greater form of privileges are usually provided to those in the group than those who are outside the group.

In contrast, the present system provides that the privileges and protection for each system user are the same since the protective features are associated with and controlled by each individual person or entity. In order to provide the most complete protection and control possible, each individual or entity that wishes to receive information from another individual or entity already in the system is also asked to join the system. This means that, in the most preferred embodiments of the present invention, each request is made on a “one-to-one” basis, between individuals or entities and the providing of information to one individual or entity does not expose the provided information to any other entity. Accordingly, the requested information is usually provided by the owner of the information as opposed to being received from a third party.

While the one-to-one nature of the present system may be incorrectly viewed as limiting in some respect, it is actually capable of providing a similar degree of functionality as the existing six-degrees of separation (SDS) systems. Existing SDS systems have a common problem in that they offer the same information profile to every individual that is connected to the same individual with the same degree of separation. In contrast, the preferred embodiments of the present invention offer a virtually unlimited number of cards or custom information profiles that can be used for various types of contact connections. This means that one custom information profile can be used for social interactions (dating, friends, etc.) while another custom information profile may be used for business-related purposes. Additionally, by providing the ability to create multiple access points for exchanging custom information profiles, it is possible to create a virtually unlimited combination of access points and custom information profiles, thereby narrowly tailoring each presentation of information to the appropriate party or parties.

Since the preferred embodiments allow for complete control and customization for information presentation and exchange, it allows the users to share only the information with the individuals and/or parties they explicitly choose. This feature means that enhanced information sharing can take place with a richer exchange of information being provided based on the enhanced ability to select and control the number and identity of the recipients. The custom information profiles of the present invention allow tremendous flexibility in the type of information sharing that can take place. Additionally, since user owns and controls their own information, each individual user can choose for themselves how many degrees they wish to view and by how many degrees of connected individuals that they wish to allow to access their information. This is in contrast to the presently known systems that provide a single option for degree of connectivity (usually four degrees of separation) with no option to choose a different level of connectivity.

While the present information exchange system has been described as a way to easily “re-connect” with prior acquaintances, it is highly likely that at some point in the future, certain unscrupulous parties may attempt to compromise the system and abuse the system for illicit, illegal, and or undesirable activities. Accordingly, many abuse detection and prevention mechanisms are available in various preferred embodiments of the present invention. For example, as described below, security system 228 of FIG. 2 may include a variety of mechanisms for abuse detection and prevention.

In the most preferred embodiments of the present invention, all browsable web pages associated with globally unique identifiers provide an opportunity for the users to report any suspected abuse by clicking on a “click here to report system abuse” button which leads to a form to report abuse. The form for reporting abuse allows a user to add comments to or simply click on a number of predetermined categories to report any suspected system abuse. This information can be collected and compiled by the system and be coordinated by security system 228 with other elements of security system 228. Security system 228 can maintain a running tally of reports against certain account holders and, if the user making the report was signed into the system when they made the report of suspected abuse, a running tally of reports made by each account holder.

A user who reaches an access point and who is not a registered user, or who is a registered user that is not signed in to the system, can still be tracked by IP address and browser ID. This information can also be matched against existing account information for registered users to better determine who is making and/or receiving system abuse reports. Security system 228 can then be set to alert the operators of the information exchange system about the potential system abuse. Additionally, the reports can be used to suspend or disable a given user account once a certain threshold of system abuse reports have been verified. To aid in this, the abuse report form could have different pre-set types of abuse that the user could select from, better enabling the system to know what type of abuse is being reported. Categories of abuse could include: “I received a spam email that contained this globally unique identifier” or “I do not know the person who sent me this connection request,” etc.

A further refinement for detecting and reporting system abuse is a system-level algorithm that tracks and correlates abuse reports made by and about system users. This system can be used to determine how accurate the abuse reports are and also used to calculate the probability that future reports will be similarly accurate. By implementing the algorithm and tracking the reliability for each user, each user's future reports can be evaluated and “weighted” (either up or down) such that a smaller number of reports from more highly weighted reporters could trigger system responses to potential system abuse. Similarly, if future abuse reports come from users with a history of unreliability, the reports may be discounted or ignored. Over time, this weighted system may be able to rapidly head off problems. For example, if an abuse report were received from a strongly weighted user (i.e., a user who has been 100% correct in 100 previous reports) may be enough to trigger an immediate suspension of the offending user's account. The actual weighting formula could be modified and adjusted over time and is preferably kept confidential to avoid manipulation of the weighting system as well. The net result of this would be that it would be a user-driven community defense system that gets better over time in which the most reliable users and reporters of abuse (and the opposite) can be easily identified and leveraged. Additional safeguards can be implemented by using human intervention in review and appeal procedures for reported system abuse.

The potential advantages of the system-generated globally unique identifiers in the addressing schema (as opposed to generating custom addresses) have been previously outlined and, while providing many advances, may be somewhat vulnerable to certain types of attacks. For example, the relatively regimented procedure of creating globally unique identifiers creates a recognizable naming pattern (e.g., letter letter letter number number number) that could be systematically evaluated and scanned for inappropriate purposes. Even if the system employed strictly custom address system, the problem would remain but may not be as attractive a target. The use of system-generated globally unique identifiers is easy to implement and a search for a specific person is less likely to return a link to a page of links since the page of links does not include any custom globally unique identifiers.

The potential for system abuse is that an outside party could systematically recreate and catalog all of the globally unique identifiers in an attempt to reveal how many accounts/addresses are used by the system or to determine that are live accounts that are susceptible to spamming. Since these addresses can be scanned by third parties without creating an account on the system, a number of defense systems may be put in place to detect and defend against this type of abuse. One such defense mechanism is the use of “decoy data pages.”

To help deter potential abuse and to detect when third parties are attempting to scan or map the public address name space, a decoy data system is deployed. When a third party tries to pull up a page that would normally be in the system name space (which starts with LLLNNN), but which is actually unassigned, a “Decoy Data Page” may be generated by the system. This means that a realistic looking web page is created that, for all practical purposes, is undetectable from a regular page. The only indication that it is not a real page would be when the third party attempts to make a connection request with the owner of the web page, whereupon, after going through the entire process of creating a connection request (thus raising the effective cost of doing so), an error page akin to the telephone systems (“number not in service, please check your number and try again”) would be given. Note also that a connection request cannot be made unless logged into a valid user account, and this attempt to connect with a Decoy Data Page would become part of the “permanent record” of that user's account. One such attempt may simply be a mistake, many such attempts are a clear sign of abuse and appropriate action can then be taken.

Once a decoy page is created, the same decoy information comes up each time in the future when that page is hit. Accounts hitting existing decoy pages and/or trying to connect with them are treated in a similar fashion as an account that triggered the creation of that decoy page. As the system name space fills up, some decoy addresses can be recycled and reassigned as “real” addresses for “real” account holders, but a percentage of all system address space pages would preferably remain available for use as decoys/“honey-pots”/beacons to detect abusive behavior. Note that this is most preferably not done outside of system name space (i.e. in custom name space) as many users may check to see if a particular custom name is in use to see if they can get it, and thus the use of decoy data for this purpose would most likely be counterproductive and possibly confusing.

Additionally, the decoy data pages can be constructed from mismatched but valid information pulled from the public information of existing user accounts (i.e., first name from one user, last name from a second user, etc.) contained in the master profile database. The use of this live data in a decoy data page may lure unsuspecting scammers, hackers and the like into exposing their undesirable activities. Once created, the URL for these decoy pages many be included in a list of URLs for legitimate users, thereby creating an additional trap for potential system abuse. By using any and/or all of these abuse detection and prevention systems, it is anticipated that the various preferred embodiments of the present invention will provide a robust and secure environment for the exchange of information.

An extension of the above, where, if not signed in as an account holder, each IP address/browser ID is tracked across the name space so that any broad scans or mapping attempts can be detected and that specific IP/Browser can be blocked from further site access (if not already on the approved list of search engine bots). Based on algorithms that take into account how many addresses are hit over a period of time, and how many, if any, were decoy addresses (either creating decoy pages or hitting existing decoy pages), etc., patterns of apparent or actual abuse can be detected and deterred (either by shaping/governing the system response to the potential abuser or shutting off access all together). If the user is signed in to an account while exhibiting such behavior, it is even easier to detect and deter. While abuse cannot be eliminated, by implementing one or more of the above-described abuse detection and prevention mechanisms, abuse can be minimized to the extent possible.

In summary, the present invention provides broad application of a unique process for managing information and providing customized views of information via computer networks such as the Internet. While the various preferred embodiments of the present invention have been described in conjunction with contact management-related information, those skilled in the art will appreciate that the apparatus and methods of the present invention are suitable for deployment in other areas as well. For example, instead of contact management, the present invention may be deployed in an environment where multiple custom information profiles for various retail products are desirable. In this fashion, one custom information profile may be provided for retailers and a separate custom information profile may be made available for dealers and/or wholesalers of the product. Similarly, custom product pricing profiles for the same product may be presented to different entities based on their access point and business profile information. By adopting the various preferred embodiments of the present invention, these and other similar systems can be easily implemented.

Lastly, it should be appreciated that the illustrated embodiments are preferred exemplary embodiments only, and are not intended to limit the scope, applicability, or configuration of the present invention in any way. Rather, the foregoing detailed description provides those skilled in the art with a convenient road map for implementing a preferred exemplary embodiment of the present invention. Accordingly, it should be understood that various changes may be made in the function and arrangement of elements described in the exemplary preferred embodiments without departing from the spirit and scope of the present invention as set forth in the appended claims.

1. An information exchange system comprising:
at least one processor;
at least one memory coupled to said at least one processor;
a profile database residing in said at least one memory; and
a data access application residing in said at least one memory;
at least a first custom profile contained in said profile database containing information entered by a first user;
at least a second custom profile contained in said profile database containing information entered by a second user; and
a link established between said first custom profile and said second custom profile by said data access application, said link being established at the direction of said first user and said second user, said link providing at least one information update to said information entered by said first user or said second user.

2. The apparatus of claim 1 further comprising a web page, said web page displaying at least a portion of said information entered by said first user.

3. The apparatus of claim 1 further comprising a web page, said web page displaying at least a portion of said information entered by said second user.

4. The apparatus of claim 1 further comprising at least one of a fax machine and a printer coupled to said information exchange system via a communication link.

5. The apparatus of claim 1 further comprising an information requesting computer and an information receiving computer coupled to said information exchange system via a communication link.

6. The apparatus of claim 1 further comprising:
an information requesting computer coupled to said information exchange system via a communication link;
an information receiving computer coupled to said information exchange system via a communication link;
a printer coupled to said information exchange system via a communication link; and
a fax machine coupled to said information exchange system via a communication link.

7. The apparatus of claim 1 further comprising:
an information requesting computer coupled to said information exchange system, said information requesting computer providing a first custom information profile to said information exchange system;
an information receiving computer coupled to said information exchange system, said information receiving computer receiving said first custom information profile, said information receiving computer providing a second information profile to said information exchange system in response to said first information profile; and
a link established by said information exchange system between said first custom information profile and said second custom information profile.

8. The apparatus of claim 1 further comprising at least one of a web server, an e-mail server, a fax server, and a security system residing in said at least one memory.

9. The apparatus of claim 8 wherein said security system comprises at least one of:
at least one decoy data page constructed from said profile database and displayed on a global computer network.

10. The apparatus of claim 1 wherein said data access application is configured to assign a globally unique identifier to said first user.

11. The apparatus of claim 1 wherein said data access application is configured to create a web page identifying said first user, said data access application incorporating said globally unique identifier in a URL for said web page.

12. The apparatus of claim 1 wherein said data access application further comprising a countdown timer, said countdown timer being configured to control the transmittal of said at least one information update.

13. A method comprising the steps of:
setting up a first user account for a first user in an information exchange system;
providing at least one identifying piece of information associated with said first user to said information exchange system;
providing said at least one identifying piece of information to at least one search engine via said information exchange system;
searching for said first user using said at least one search engine; and
locating said at least one identifying piece of information using said at least one search engine.

14. The method of claim 13 further comprising the steps of:
creating a second user account for a second user in said information exchange system;
sending a first information profile from said second user to said first user;
sending a second information profile from said first user to said second user; and
exchanging a link via said information exchange system between said first user and said second user.

15. The method of claim 13 wherein said at least one search engine is an Internet-based search engine provided by at least one of Google, Yahoo, or Microsoft.

16. The method of claim 13 further comprising the step of creating a decoy data page using information from said first information profile and said second information profile.

17. The method of claim 13 further comprising the step of creating an incoming request queue for said first user, said incoming request queue being configured to store incoming requests.

18. The method of claim 13 further comprising the step of creating an outgoing request queue for said first user, said outgoing request queue being configured to store outgoing requests.

19. A method of providing updates to contact information comprising the steps of:
a. performing an information update on at least one information field in an information profile, thereby creating updated information;
b. setting a countdown timer at the completion of said information update, said countdown timer defining a waiting duration;
c. measuring the amount of time elapsed since the most recent information update, thereby creating an update time;
d. transmitting said updated information only when said update time exceeds said waiting duration.

20. The method of claim 19 further comprising the step of repeatedly performing steps a-d.

21. The method of claim 19 wherein said waiting duration is a user adjustable parameter.

22. The method of claim 19 wherein said waiting duration is a system adjustable parameter.

23. The method of claim 19 wherein said countdown timer controls the release of multiple information updates for a plurality of users.

24. A method comprising the steps of:
identifying a source of information;
contacting said source of information using a globally unique identifier via a first communication medium and initiating a first request for at least one item of information contained within said source of information, said globally unique identifier being used to uniquely identify said at least one item of information, said globally unique identifier being incorporated into said request for said at least one item of information;
receiving an automated answer from said source of information via said first form of communication in response to said contact, said automated message identifying a second form of communication, said automated message including said globally unique identifier;
initiating a second request to receive said at least one item of information, using said second form of communication and incorporating globally unique identifier to identify said at least one item of information.

25. The method of claim 24, said first communication medium being the Internet and said first request incorporating said globally unique identifier into a URL for a web page.

26. The method of claim 24, said second communication medium being a standard telephone system and said globally unique identifier comprising an extension for a phone number.

27. The method of claim 24, said second communication medium being the Internet and said second request incorporating said globally unique identifier into a URL for a web page.

28. The method of claim 24, said first communication medium being a standard telephone system and said globally unique identifier comprising an extension for a phone number.

29. The method of claim 24, said first communication medium being the Internet and said first request incorporating said globally unique identifier into an e-mail address.

30. The method of claim 24, said second communication medium being the Internet and said second request incorporating said globally unique identifier into an e-mail address.

31. A method of automatically forming groups in a contact management system comprising the steps of:
allowing a plurality of users in said contact management system to voluntarily create a plurality of groups;
allowing at least some of said plurality of users to associate themselves with at least one of said plurality of groups, thereby creating a plurality of group affiliations,
observing the group affiliations created by said plurality of users; and
creating at least one groups based on said plurality of group affiliations.

32. The method of claim 38 further comprising the step of providing group information to at least one of said plurality of users based on said plurality of group affiliations.

33. The method of claim 38 further comprising the step of differentiating at least a first user in said plurality of users from at least a second user in said plurality of users based on said plurality of group affiliations.

34. The method of claim 40 further comprising the step of providing contact information for said first user in said plurality of users based on said group affiliations.

35. A program product comprising:
a profile database configured to store a plurality of information profiles;
a data access application, said data access application being configured to establish a link between a first information profile and a second information profile at the request of a first user and a second user, said link being configured to update said first information profile and said second information profile, and;
signal bearing media bearing said program product.

36. The program product of claim 35 wherein said signal bearing media comprises at least one of recordable media and transmission media.

37. The program product of claim 35 wherein each of said plurality of information profiles is configured to store personally identifiable contact information.

38. The program product of claim 35 further comprising a security system, said security system being configured to construct at least one decoy data page from said plurality of information profiles stored in said profile database.

39. The program product of claim 35 wherein said data access application is configured to make at least a portion of said first information profile or said second information profile to at least one search engine.

40. The program product of claim 39 wherein said at least one search engine is an Internet-based search engine provided by at least one of Google, Yahoo, or Microsoft.

41. The program product of claim 35 wherein said data access application is configured to observe a plurality of group affiliations and create at least one group based on said plurality of group affiliations.

42. The program product of claim 37 wherein said data access application is configured to provide side links for said personally identifiable contact information.

43. A method of directing a person to a desired contact information related website for a first individual, said method comprising the steps of:
creating a globally unique identifier to identify said first individual;
using said globally unique identifier as a telephone extension for a telephone number identifying said first individual;
providing a prerecorded message to at least one caller of said telephone number directing said at least one caller to use a web browser to navigate to a web page, said globally unique identifier being incorporated into a URL for said contact information related website, thereby directing said at least one caller to said contact information related website for said first individual.

44. The method of claim 43 further comprising the step of exchanging information between said at least one caller and said first individual, thereby establishing a link between said caller and said first individual.

45. The method of claim 43 wherein said telephone number and said extension are printed on a business card.
